(19) United States
(12) Patent Application Publication
(10) Pub. No.: US 2020/0219013 A1
(43) Pub. Date: Jul. 9, 2020

(54) MACHINE LEARNING FACTORY

(71) Applicant: PurePredictive, Inc., Sandy, UT (US)

(72) Inventors: Richard W. WELLMAN, Park City, UT (US); Kelly D. PHILLIPPS, Salt Lake City, UT (US)

(73) Assignee: PurePredictive, Inc., Sandy, UT (US)

(21) Appl. No.: 16/823,229

(22) Filed: Mar. 18, 2020

Related U.S. Application Data
(63) Continuation of application No. 14/266,093, filed on Apr. 30, 2014.
Application No. 14/266,093 is a continuation-in-part of application No. 13/725,995, filed on Dec. 21, 2012, now abandoned.
Application No. 13/725,995 is a continuation-in-part of application No. 13/749,618, filed on Jan. 24, 2013, now abandoned.
Application No. 13/749,618 is a continuation-in-part of application No. 13/870,861, filed on Apr. 25, 2013, now Pat. No. 8,880,446.
(60) Provisional application No. 61/727,114, filed on Nov. 15, 2012.

(51) Int. Cl. G06N 20/00; G06Q 30/02; G06F 16/957; G06F 16/9535

(52) U.S. Cl. CPC G06N 20/00; G06Q 30/0202; G06Q 30/0207; G06F 16/9535; G06F 16/957

(57) ABSTRACT

Apparatuses, systems, methods, and computer program products are disclosed for a machine learning factory. A receiver module is configured to receive electronically transmitted training data. A function generator module is configured to generate executable program code for a plurality of learned functions from a plurality of different machine learning classes based on training data. A function evaluator module is configured to perform a machine learning evaluation of a plurality of learned functions using test data and configured to maintain evaluation metadata in one or more non-transitory computer readable storage media. A predictive compiler module is configured to compile executable program code from a subset of multiple learned functions to form a machine learning ensemble comprising the subset of multiple learned functions and a rule set synthesized from evaluation metadata to direct different subsets of data through executable program code for different learned functions of the subset of multiple learned functions.

### CROSS-REFERENCES TO RELATED APPLICATIONS

This is a continuation of and claims priority to U.S. patent application Ser. No. 14/266,093 entitled “MACHINE LEARNING FOR REAL-TIME ADAPTIVE WEBSITE INTERACTION” and filed on Apr. 30, 2014 for Kelly D. Phillipps et al., which is a continuation-in-part application of and claims priority to U.S. patent application Ser. No. 13/725,995 entitled “MACHINE LEARNING FOR SYSTEMS MANAGEMENT” and filed on Dec. 21, 2012 for Kelly D. Phillipps et al., U.S. patent application Ser. No. 13/749,618 entitled “MACHINE LEARNING FOR STUDENT ENGAGEMENT” and filed on Jan. 24, 2013 for Richard W. Wellman et al., and U.S. patent application Ser. No. 13/870,861 entitled “PREDICTIVE ANALYTICS FACTORY” and filed on Apr. 25, 2013 for Richard W. Wellman et al., which claims the benefit of U.S. Provisional Patent Application No. 61/727,114 entitled “PREDICTIVE ANALYTICS FACTORY” and filed on Nov. 15, 2012 for Richard W. Wellman, et al., each of which is incorporated herein by reference.

### TECHNICAL FIELD

The present disclosure, in various embodiments, relates to machine learning and more particularly relates to an automated factory for machine learning.

### BACKGROUND

Data analytics models are typically highly tuned and customized for a particular application. Such tuning and customization often requires pre-existing knowledge about the particular application, and can require the use of complex manual tools to achieve this tuning and customization. For example, an expert in a certain field may carefully tune and customize an analytics model for use in the expert's field using a manual tool.

While a highly tuned, expert customized analytics model may be useful for a particular application or field, because of the high level of tuning and customization, the analytics model is typically useless or at least inaccurate for other applications and fields. Conversely, a general purpose analytics framework typically is not specialized enough for most applications without substantial customization.

### SUMMARY

From the foregoing discussion, it should be apparent that a need exists for an apparatus, system, method, and computer program product to generate a machine learning ensemble in an automated manner. Beneficially, such an apparatus, system, method, and computer program product would comprise a machine learning factory configured to generate a machine learning ensemble regardless of the particular field or application, with little or no input from a user or expert.

The present disclosure has been developed in response to the present state of the art, and in particular, in response to the problems and needs in the art that have not yet been fully solved by currently available machine learning methods. Accordingly, the present disclosure has been developed to provide an apparatus, system, method, and computer program product for a machine learning factory that overcome many or all of the above-discussed shortcomings in the art.

Apparatuses are presented for a machine learning factory. In one embodiment, a receiver module is configured to receive electronically transmitted training data over a data network using a network interface. Training data, in some embodiments, is for forming a machine learning ensemble customized for the training data. A function generator module, in certain embodiments, is configured to pseudo-randomly generate executable program code for a plurality of learned functions from a plurality of different machine learning classes using parallel computing on multiple processors based on training data. Different machine learning classes, in some embodiments, are selected without regard to a suitability of a plurality of learned functions and of the different machine learning classes for training data. A total number of a plurality of learned functions, in one embodiment, are selected so that at least a subset of the plurality of learned functions are pseudo-randomly suitable for training data. A function evaluator module, in certain embodiments, is configured to perform a machine learning evaluation of a plurality of learned functions using test data. A function evaluator module, in one embodiment, is configured to maintain evaluation metadata for a plurality of learned functions in one or more non-transitory computer readable storage media. In some embodiments, evaluation metadata comprises an indicator of a training data set used to generate a learned function and/or an indicator of one or more decisions made by a learned function during a machine learning evaluation. A machine learning compiler module, in a further embodiment, is configured to compile executable program code from a subset of multiple learned functions from a plurality of learned functions to form a machine learning ensemble. A machine learning ensemble, in some embodiments, includes a subset of multiple learned functions selected and combined based on evaluation metadata for a larger plurality of learned functions. A machine learning ensemble, in one embodiment, includes a rule set synthesized from evaluation metadata to direct data through multiple learned functions so that executable program code from different learned functions of a machine learning ensemble processes different subsets of the data based on evaluation metadata. A machine learning ensemble, in a further embodiment, includes a rule set synthesized from evaluation metadata to direct data through multiple learned functions so that executable program code from one or more of multiple learned functions receives output from executable program code of at least one other learned function of the multiple learned functions as an input.

Other apparatuses are presented for a machine learning factory. In one embodiment, an apparatus includes means for generating executable program code for a plurality of learned functions from a plurality of different machine learning classes based on training data without regard to a suitability of the plurality of learned functions or of the different machine learning classes for the training data. Training data, in some embodiments, is received for forming a machine learning ensemble customized for the training data. An apparatus, in a further embodiment, includes means for evaluating a plurality of learned functions using test data to generate evaluation metadata stored in one or more non-transitory computer readable storage media. Evaluation metadata, in some embodiments, indicates an effectiveness of different learned functions at making predictions based on different subsets of test data. In certain embodiment, an apparatus includes means for compiling executable program code from a subset of multiple learned functions from a plurality of learned functions to form a machine learning ensemble comprising a subset of multiple learned functions selected and combined based on evaluation metadata. A machine learning ensemble, in some embodiments, includes a rule set synthesized from evaluation metadata to direct different subsets of workload data through executable program code from different learned functions of multiple learned functions based on the evaluation metadata.

Computer program products are presented, comprising a computer readable storage medium storing computer usable program code executable to perform operations for a machine learning factory. In one embodiment, an operation includes determining executable program code for a plurality of learned functions from a plurality of different machine learning classes using training data without regard to a suitability of the plurality of learned functions or of the different machine learning classes for the training data. Training data, in some embodiments, comprises a plurality of features. Training data, in a further embodiment, is received for forming a machine learning ensemble customized for the training data. An operation, in certain embodiments, includes selecting a subset of features of training data based on evaluation metadata generated for a plurality of learned functions and stored in one or more non-transitory computer readable storage media. Evaluation metadata, in some embodiments, includes an effectiveness metric for a learned function. In a further embodiment, an operation includes compiling executable program code from a subset of multiple learned functions from a plurality of learned functions to form a machine learning ensemble comprising at least two learned functions from the plurality of learned functions that use a selected subset of features. At least learned functions, in one embodiment, are selected and combined based on evaluation metadata. A machine learning ensemble, in some embodiments, includes a rule set synthesized from evaluation metadata to direct data through executable program code from at least two learned functions so that executable program code from different learned functions processes different features of a selected subset of features.

A machine learning ensemble is presented. In one embodiment, a machine learning ensemble includes executable program code for multiple learned functions synthesized from executable program code for a larger plurality of learned functions from a plurality of different machine learning classes. Multiple learned functions, in some embodiments, are selected and combined based on evaluation metadata for an evaluation of a larger plurality of learned functions generated based on training data without regard to a suitability of the larger plurality of learned functions or of different machine learning classes for the training data. In a further embodiment, a machine learning ensemble includes a metadata rule set synthesized from evaluation metadata for a plurality of learned functions for directing data through executable program code of different learned functions of multiple learned functions to produce a result. A predictive analytics ensemble, in one embodiment, includes an orchestration module configured to direct data through executable program code of different learned functions of multiple learned functions based on a synthesized metadata rule set to produce a result.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. The disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a schematic block diagram illustrating one embodiment of a system for website interaction;

FIG. 2A is a schematic block diagram illustrating one embodiment of a website interaction module;

FIG. 2B is a schematic block diagram illustrating another embodiment of a website interaction module;

FIG. 3 is a schematic block diagram illustrating one embodiment of a machine learning module;

FIG. 4 is a schematic block diagram illustrating one embodiment of a system for a machine learning factory;

FIG. 5 is a schematic block diagram illustrating one embodiment of learned functions for a machine learning ensemble;

FIG. 6 is a schematic flow chart diagram illustrating one embodiment of a method for a machine learning factory;

FIG. 7 is a schematic flow chart diagram illustrating another embodiment of a method for a machine learning factory;

FIG. 8 is a schematic flow chart diagram illustrating one embodiment of a method for directing data through a machine learning ensemble;

FIG. 9 is a schematic flow chart diagram illustrating one embodiment of a method for website interaction; and

FIG. 10 is a schematic flow chart diagram illustrating another embodiment of a method for website interaction.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

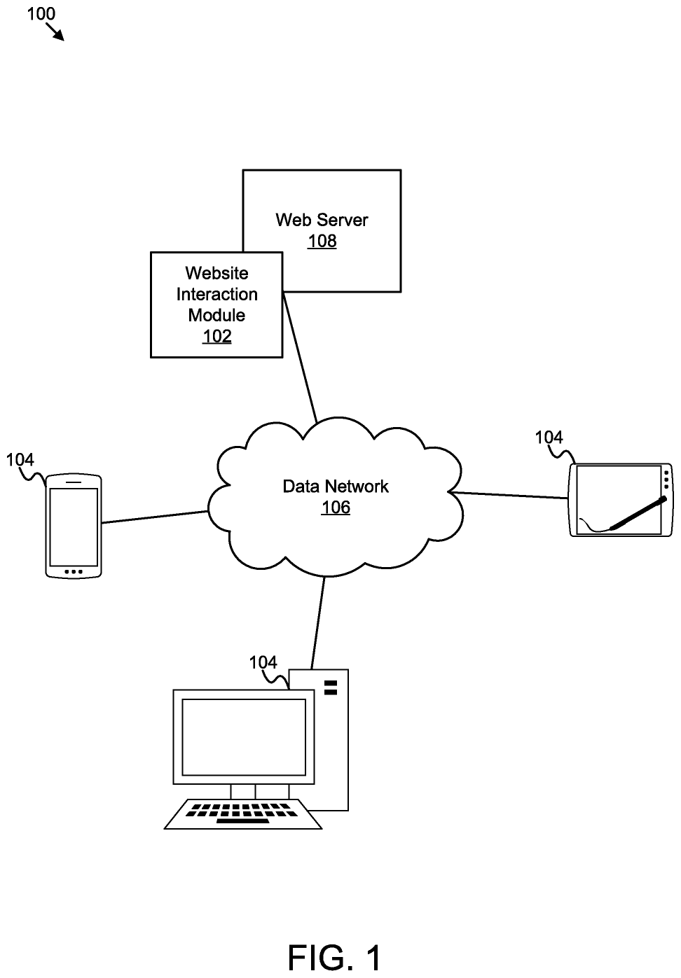

FIG. 1 depicts one embodiment of a system 100 for website interaction. The system 100, in the depicted embodiment, includes a website interaction module 102, a web server 108, a data network 106, and one or more clients 104. In the depicted embodiment, the web server 108 may deliver website content, such as web pages, to one or more clients 104 over a data network 106. In one embodiment, a client 104 may include any device capable of displaying website content for a user. For example, in some embodiments, clients 104 may include devices such as a desktop computer, a laptop computer, a tablet, a smartphone or other mobile device, or the like. In another embodiment, a web server 108 may be any server capable of delivering website content to a client 104 over a data network 106. For example, in some embodiments, a web server 108 may include a standalone server, a dedicated server, a virtual server, a blade server, a cluster of servers, or the like. In many embodiments, the data network 106 connecting a web server 108 to clients 104 is the Internet; however, in another embodiment, the data network 106 may include another type of network, such as an intranet network, a local area network (LAN), a metropolitan area network (MAN), a wide area network (WAN), or the like.

In general, the website interaction module 102 operates with the web server 108 to customize or adapt website content for individual users or clients 104 in real-time. In one embodiment, the website interaction module 102 may be configured to receive information associated with a user of a website from multiple sources. In a further embodiment, the website interaction module 102 may be configured to apply machine learning to the received information to produce a machine learning result. In a certain embodiment, the website interaction module 102 may be configured to adapt the website for the user in real-time based on the machine learning result. In some embodiments, using machine learning may allow the website interaction module 102 to adapt a website for individual users more efficiently than it could by using experts to customize or tune website adaptation rules. In further embodiments, basing the machine learning on information from multiple sources may allow the website interaction module 102 to adapt a website more specifically for individual users than it could by using information from only one source.

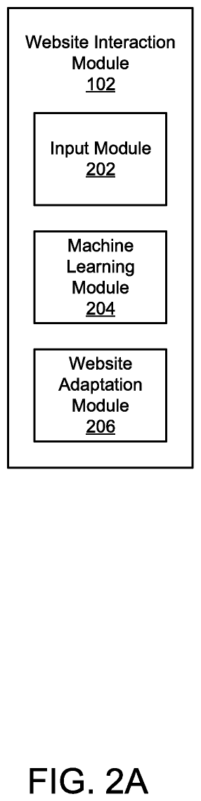

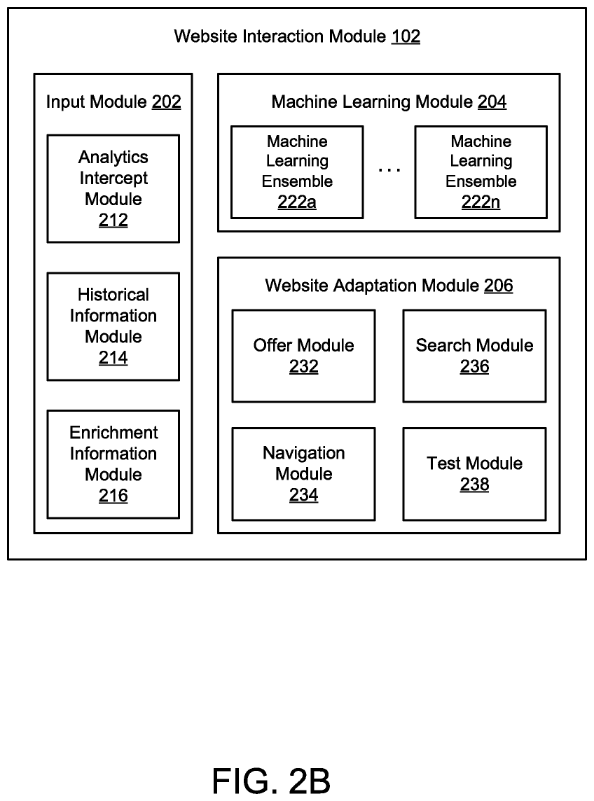

In one embodiment, the website interaction module 102 may operate as part of the web server 108. In another embodiment, the website interaction module 102 may operate on another computer or other server in communication with the web server 108 over a local bus or a data network 106. In a further embodiment, the website interaction module 102 may operate in communication with multiple web servers 108, to adapt website content in real-time for multiple websites. The website interaction module 102 is described in greater detail below with regard to FIGS. 2A and 2B.

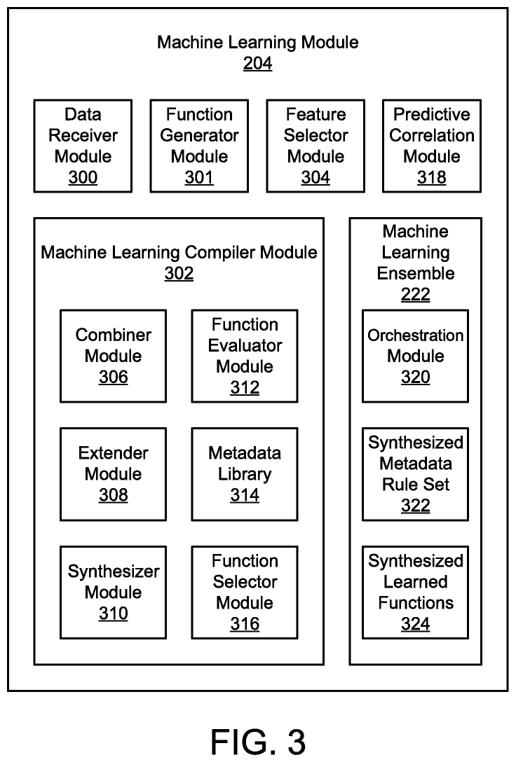

In certain embodiments, the website interaction module 102 provides and/or accesses a machine learning framework allowing a web server 108 to request machine learning ensembles, to make analysis requests (e.g., processing collected and coordinated data using machine learning), and to receive machine learning results, such as a classification, a confidence metric, an inferred function, a regression function, an answer, a prediction, a recognized pattern, a rule, a recommendation, a marketing offer, a navigation link, a suggested search term, a search result, or other results. Machine learning, as used herein, comprises one or more modules, computer executable program code, logic hardware, and/or other entities configured to learn from or train on input data, and to apply the learning or training to provide results or analysis for subsequent data. Machine learning and generating machine learning ensembles or other machine learning program code is described in greater detail below with regard to FIG. 3 through FIG. 8.

In one embodiment, the website interaction module 102 may provide, access, or otherwise use predictive analytics. Predictive analytics is the study of past performance, or patterns, found in historical and transactional data to identify behavior and trends in future events, using machine learning or the like. This may be accomplished using a variety of statistical techniques including modeling, machine learning, data mining, or the like.

One term for large, complex, historical data sets is Big Data. Examples of Big Data include web logs, social networks, blogs, system log files, call logs, customer data, user feedback, or the like. These data sets may often be so large and complex that they are awkward and difficult to work with using traditional tools. With technological advances in computing resources, including memory, storage, and computational power, along with frameworks and programming models for data-intensive distributed applications, the ability to collect, analyze and mine these huge repositories of structured, unstructured, and/or semi-structured data has only recently become possible.

In certain embodiments, a prediction may be applied through at least two general techniques: Regression and Classification. Regression models attempt to fit a mathematical equation to approximate the relationship between the variables being analyzed. These models may include “Discrete Choice” models such as Logistic Regression, Multinomial Logistic Regression, Probit Regression, or the like. When factoring in time, Time Series models may be used, such as Auto Regression—AR, Moving Average—MA, ARMA, AR Conditional Heteroskedasticity—ARCH, Generalized ARCH—GARCH and Vector AR—VAR). Other models include Survival or Duration analysis, Classification and Regression Trees (CART), Multivariate Adaptive Regression Splines (MARS), and the like.

Classification is a form of artificial intelligence that uses computational power to execute complex algorithms in an effort to emulate human cognition. One underlying problem, however, remains: determining the set of all possible behaviors given all possible inputs is much too large to be included in a set of observed examples. Classification methods may include Neural Networks, Radial Basis Functions, Support Vector Machines, Naïve Bayes, k-Nearest Neighbors, Geospatial Predictive modeling, and the like.

Each of these forms of modeling make assumptions about the data set and model the given data, however, some models are more accurate than others and none of the models are ideal. Historically, using predictive analytics or other machine learning tools was a cumbersome and difficult process, often involving the engagement of a Data Scientist or other expert. Any easier-to-use tools or interfaces for general business users, however, typically fall short in that they still require “heavy lifting” by IT personnel in order to present and massage data and results. A Data Scientist typically must determine the optimal class of learning machines that would be the most applicable for a given data set, and rigorously test the selected hypothesis by first fine-tuning the learning machine parameters and second by evaluating results fed by trained data.

The website interaction module 102, in certain embodiments, generates machine learning ensembles or other machine learning program code for a web server 108, with little or no input from a Data Scientist or other expert, by generating a large number of learned functions from multiple different classes, evaluating, combining, and/or extending the learned functions, synthesizing selected learned functions, and organizing the synthesized learned functions into a machine learning ensemble. The website interaction module 102, in one embodiment, services analysis requests for the web server 108 using the generated machine learning ensembles or other machine learning program code.

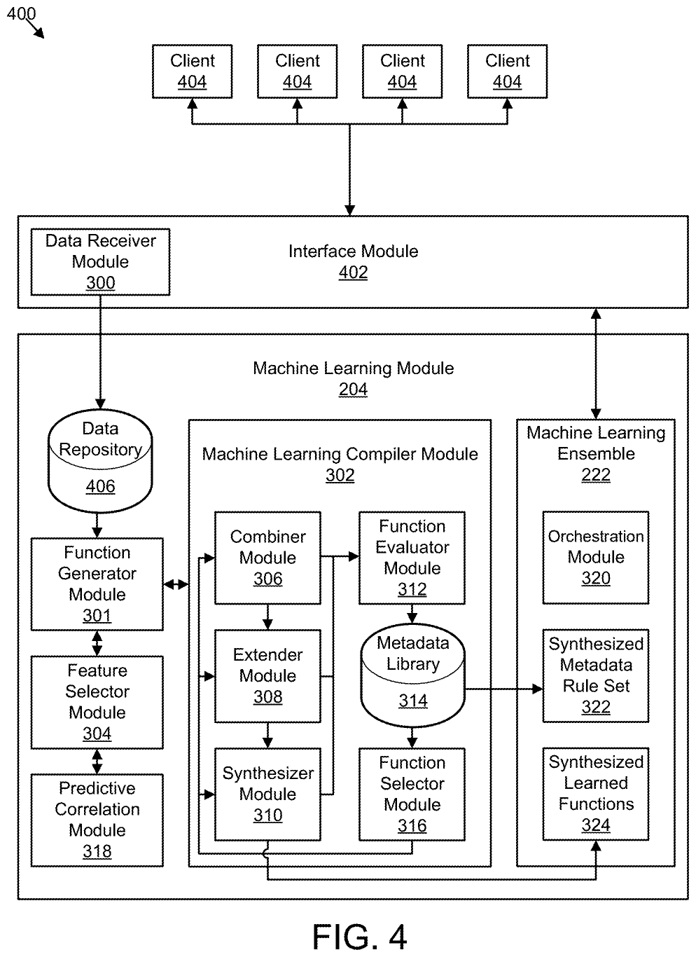

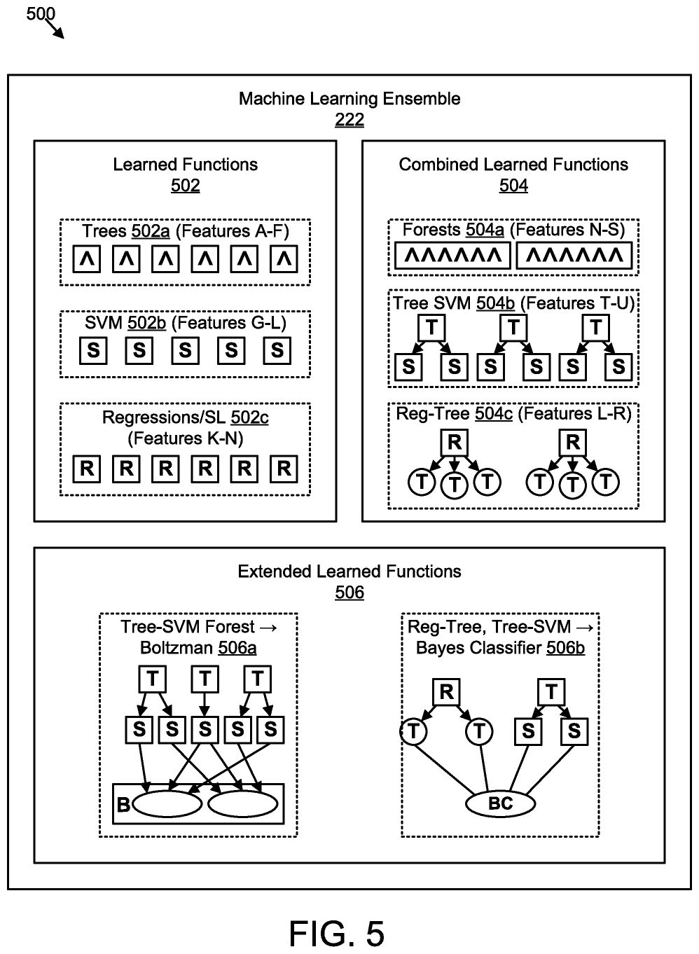

By generating a large number of learned functions, without regard to the effectiveness of the generated learned functions, without prior knowledge of the generated learned functions suitability, or the like, and evaluating the generated learned functions, in certain embodiments, the website interaction module 102 may provide machine learning ensembles or other machine learning program code that are customized and finely tuned for a particular website, a specific user, or the like, without excessive intervention or fine-tuning. The website interaction module 102, in a further embodiment, may generate and evaluate a large number of learned functions using parallel computing on multiple processors, such as a massively parallel processing (MPP) system or the like. Machine learning ensembles or other machine learning program code are described in greater detail below with regard to FIG. 3, FIG. 4, and FIG. 5.

FIG. 2A depicts one embodiment of a website interaction module 102. The website interaction module 102, in certain embodiments, may be substantially similar to the website interaction module 102 described above with regard to FIG. 1. In general, as described above, the website interaction module 102 applies machine learning to information from multiple sources to adapt a website for one or more users. In the depicted embodiment, the website interaction module 102 includes an input module 202, a machine learning module 204, and a website adaptation module 206.

The input module 202, in one embodiment, is configured to receive information associated with a user of a website. In one embodiment, the website may be served by one or more web servers 108, and the user may use a client 104 to access the website via the data network 106. In some embodiments, information associated with a user and received by the input module 202 provides a basis for the website interaction module 102 to customize or adapt the website for the user. In certain embodiments, information associated with the user may include any information about the user or relating to the user. For example, in some embodiments, information associated with the user may include data used by a web analytics service and associated with the user, business historical information such as a user's search, navigation, or purchase history on the website, information about items purchased or pages visited by the user, information about the user from other websites, information about the user's location, information about the type of client 104 with which the user accesses the website, information about the user's web browser, or the like. In one embodiment, the input module 202 may receive information directly associated with the user, such as information about the user. In another embodiment, the input module 202 may receive information indirectly associated with the user, such as information about similar users, information about items or pages associated with the user, information about another user associated with the user via a social networking service, or the like. Many types of information that may be associated with a user are clear in light of this disclosure. Certain types of information associated with a user, which the input module 202 may receive, in various embodiments, are discussed in greater detail below with regard to the analytics intercept module 212, historical information module 214, and enrichment information module 216 of FIG. 2B

In one embodiment, the input module 202 may receive information associated with the user from multiple sources. In certain embodiments, information received by the input module 202 from multiple sources may allow the website interaction module 102 to customize or adapt the website for the user more accurately than it could with information from a single source. In various embodiments, a source may include any repository of information associated with one or more users, or any channel for gathering or communicating information associated with one or more users. For example, in one embodiment, information from multiple sources may include information from the website and information from a source external to the website. However, in another embodiment, information from multiple sources may include information from two sources that both originate with the user's interactions with the website, but that are gathered or received by the input module 202 in different ways. For example, in one embodiment, information from multiple sources may include website business data, such as the user's purchase history on the website, or the like, and web analytics data relating to the user's actions on the website, but intended for a web analytics service such as Omniture®, Google® Analytics, or the like.

In one embodiment, the input module 202 may receive information from a source by actively querying the source. For example, in some embodiments, the input module 202 may query a database to determine a user's purchase history on the website. In another embodiment, the input module 202 may include an interface for passively receiving information from a source as the source sends it. For example, in one embodiment, the input module 202 may include an interface that “listens” to a weather service to receive weather updates about the user's location on a regular basis. In a certain embodiment, the input module 202 may receive information directly from multiple sources. For example, in one embodiment, the input module 202 may include multiple interfaces for actively querying or passively receiving updates from multiple sources. In another embodiment, the input module 202 may receive information already aggregated from multiple sources. For example, in one embodiment, the input module 202 may include an interface for uploading data that has been aggregated from multiple sources by the web server 108, a data scientist for the website, or the like.

The machine learning module 204, in one embodiment, is configured to apply machine learning to the information from the input module 202, to produce a machine learning result. In certain embodiments, the machine learning module 204 may input the information into machine learning to produce a machine learning result. In some embodiments, using machine learning allows the website interaction module 102 to adapt the website for one or more users with little or no input from a Data Scientist or other expert.

In one embodiment, the machine learning module 204 may apply machine learning to the information received by the input module 202. As described above, machine learning may include one or more modules, computer executable program code, logic hardware, and/or other entities configured to learn from or train on input data, and to apply the learning or training to provide results or analysis for subsequent data. In certain embodiments, the machine learning module 204 may apply machine learning including one or more learned functions, combined learned functions, extended learned functions, synthesized learned functions, machine learning ensembles or the like, as described below with regard to FIG. 2B, FIG. 3, FIG. 4, and FIG. 5.

In a further embodiment, the machine learning module 204 may produce a machine learning result. In various embodiments, machine learning results may include various types of results obtained by applying a learned function, machine learning ensemble, or the like to the information associated with the user. For example, in certain embodiments, a machine learning result may include a classification, a confidence metric, an inferred function, a regression function, an answer, a prediction, a recognized pattern, a rule, a recommendation, a marketing offer, a navigation link, a suggested search term, a search result, or other results.

In some embodiments, the machine learning result may include a prediction about the user's response to a particular adaptation of the website for the user. For example, in one embodiment, the machine learning result may include a prediction that the user will make a purchase if the website is adapted to present a particular marketing offer. In another embodiment, the machine learning result may include a prediction that the user will navigate to a certain page if the website is adapted to present navigation links in a certain way. In a certain embodiment, the machine learning result may include a prediction of what suggested search terms and/or search results may be most useful to a user.

In another embodiment, the machine learning result from the machine learning module 204 may not include a direct prediction about the user's response to a website adaptation, but may include a result that the website interaction module 102 uses to adapt the website in another way. For example, in one embodiment, the machine learning module 204 may produce a statistical machine learning result such as a classification, a confidence metric, or the like, which the website interaction module 102 uses as an input to additional machine learning or rules for adapting the website.

The website adaptation module 206, in one embodiment, is configured to adapt the website for the user in real-time based on the machine learning result from the machine learning module 204. In various embodiments, the website adaptation module 206 may configure, customize, or adapt the website for the user by cooperating with the web server 108 and/or the user's client 104 to configure the presentation of at least a portion of the website based on the machine learning result from the machine learning module 204. For example, the website adaptation module 206 may configure the presentation of marketing offers, navigation links, suggested search terms, search results, or the like, that the user would not otherwise see, or would otherwise see in a different form. In light of this disclosure, many ways are clear in which the website adaptation module 206 may adapt the website for the user. Certain ways in which the website adaptation module 206 may adapt the website for the user are discussed in greater detail below with regard to the offer module 232, navigation module 234, search module 236, and test module 238 of FIG. 2B.

In one embodiment, the website adaptation module 206 may adapt the website for the user in real-time. As used herein, adapting a website in “real-time” refers to making any changes, customizations, or adaptations during a single session for the user on the website, rather than after the end of the session. For example, in one embodiment, the input module 202 may be configured to receive information in response to the user visiting the website, and the website adaptation module 206 may be configured to adapt the website for the user in real-time by customizing presentation of the website for the user during the visit, browsing session, or the like, based on the machine learning result from the machine learning module 204.

In one embodiment, the website adaptation module 206 may adapt the website for the user in real-time by adapting a page of the website in response to the user's request for the page. For example, in a further embodiment, the user may request a page of the website, and may receive a customized version of the page with navigation links, marketing offers, or the like configured by the website adaptation module 206. In another embodiment, the website adaptation module 206 may adapt a page of the website for the user while the user is viewing the page. For example, in a further embodiment, the website adaptation module 206 may provide customized navigation links, marketing offers, or the like, while the user is viewing a page of an AJAX-based web application, or the like, which allows the page to be changed without reloading. In light of this disclosure, many ways of adapting a website in real-time are clear. By adapting the website for the user in real-time, the website adaptation module 206 may allow a user to respond to adaptations to the website in one session, instead of at a later time. In certain embodiments, marketing offers or the like may be more effective if they are presented by the website adaptation module 206 as a real-time adaptation to the website instead of being presented in another way, such as via email, for a subsequent session.

FIG. 2B depicts another embodiment of a website interaction module 102. The website interaction module 102, in certain embodiments, may be substantially similar to the website interaction module 102 described above with regard to FIG. 1 and FIG. 2A. In the depicted embodiment, the website interaction module 102 includes an input module 202, a machine learning module 204, and a website adaptation module 206, which may be configured substantially as described above with regard to FIG. 2A. The input module 202, in the depicted embodiment, includes an analytics intercept module 212, a historical information module 214, and an enrichment information module 216. The machine learning module 204, in the depicted embodiment, includes one or more machine learning ensembles 222a-n. The website adaptation module 206, in the depicted embodiment, includes an offer module 232, a navigation module 234, a search module 236, and a test module 238.

In one embodiment, the input module 202 may receive information associated with the user by using the analytics intercept module 212. In the depicted embodiment, the analytics intercept module 212 is configured to intercept information intended for a web analytics service for the website, or to intercept information from communication between the website and a web analytics service. In various embodiments, a web analytics service for the website may include any service that collects or analyzes data about what users do when visiting the website. In further embodiments, information intended for a web analytics service may include any information gathered for or sent to a web analytics service. For example, in certain embodiments, web analytics services such as Google® Analytics, Omniture®, and the like, may provide scripts that the website embeds in its web pages. When the user requests a page with an embedded script, the script may run on the web server 108 or the user's client 104 to send information such as page view duration, click path (or sequence of page views), referrer, modality (e.g., desktop or mobile browser), information about repeatedly visited pages, and the like, to the web analytics service.

In certain embodiments, the analytics intercept module 212 may intercept this information. For example, in one embodiment, a website administrator may modify the web analytics scripts to duplicate the information sent to the web analytics service and send the duplicated information to the analytics intercept module 212. In another embodiment, the analytics intercept module 212 may run additional client-side and/or server-side scripts which monitor network traffic for information sent to a web analytics service, and copy the information en route. In light of this disclosure, many ways of intercepting information intended for a web analytics service are clear. In various embodiments, using the analytics intercept module 212 to intercept information intended for a web analytics service allows the input module 202 to provide useful information associated with a user to the machine learning module 204 without using additional resources beyond those already used by the web analytics service to generate the information.

In one embodiment, the input module 202 may receive information associated with the user by using the historical information module 214. In the depicted embodiment, the historical information module 214 is configured to receive historical information from an owner of the website. In certain embodiments, historical information may include information about past events, such as a user's purchase history, navigation history, or the like. In one embodiment, historical information from an owner of the website may include historical information relating specifically to that website. However, in another embodiment, historical information from an owner of the website may include historical information relating to another, co-owned website, or to a network of related websites. For example, in one embodiment, historical information may include a user's purchase and/or navigation history website, for multiple co-owned or otherwise affiliated websites.

In one embodiment, the historical information module 214 may receive historical information directly from the web server 108 for the website, by querying databases, monitoring log files, or the like. In another embodiment, the historical information module 214 may provide an interface for the website owner to upload historical information. In view of this disclosure, many types of historical information and ways of receiving historical information are clear. In various embodiments, using the historical information module 214 to receive historical information from an owner of the website allows the input module 202 to provide information to the machine learning module 204 about the user's past behavior, which may suggest certain adaptations to the website.

In one embodiment, the input module 202 may receive information associated with the user by using the enrichment information module 216. In the depicted embodiment, the enrichment information module 216 is configured to receive enrichment information from one or more sources external to the website. In certain embodiments, “enrichment information” may refer to information associated with the user, but not otherwise associated with the website. For example, in various embodiments, enrichment information may include location information, weather information, seasonal information, crime rate information, social media information, or the like for the user. In one embodiment, the enrichment information may include current information, such as information about the current weather in a user's location, or information about a user's current social media connections. In another embodiment, the enrichment information may include past information, such as information about previous weather patterns in the user's location, or information about a user's previous posting activity on social media websites.

In one embodiment, the enrichment information module 216 may receive enrichment information about one user in response to querying one or more external databases, websites, or other services. For example, in a certain embodiment, the enrichment information module 216 may query a weather service to receive information about the weather in a user's location. In another embodiment, the enrichment information module 216 may receive information in bulk, and select the information associated with the user. For example, in a further embodiment, the enrichment information module 216 may receive and store crime rate information for multiple locations, and may search the stored information for information about the crime rate in the user's location. In view of this disclosure, several ways of receiving enrichment information, and several types of enrichment information, are clear. In various embodiments, using the enrichment information module 216 to receive enrichment information from an external source allows the input module 202 to provide additional input to the machine learning module 204, which may suggest certain adaptations to the website.

In one embodiment, the machine learning module 204 may produce a machine learning result by using a plurality of machine learning ensembles 222a-n. In some embodiments, the machine learning module 204 is configured to form the machine learning as described below with regard to FIGS. 3, 4, and 5. In further embodiments, the machine learning may include a plurality of machine learning ensembles 222a-n, so that different machine learning ensembles 222a-n produce different types of machine learning results. For example, in one embodiment, various machine learning ensembles 222a-n may produce machine learning results for different types of website adaptations (e.g., marketing offers, adapted navigation links, search results, or the like), different rules or heuristics for adapting the website, or the like. As a further example, in one embodiment, individual machine learning ensembles 222a-n may be associated with search, navigation, individual marketing offers, particular user attributes (such as whether the user is a new or returning customer, a mobile or desktop user, etc.), or the like.

The machine learning module 204, in certain embodiments, generates machine learning ensembles 222a-n with little or no input from a Data Scientist or other expert, by generating a large number of learned functions from multiple different classes, evaluating, combining, and/or extending the learned functions, synthesizing selected learned functions, and organizing the synthesized learned functions into a machine learning ensemble 222, so that each machine learning ensemble 222a-n includes a plurality of learned functions. The machine learning module 204, in one embodiment, produces machine learning results with input from the input module 202 using the generated one or more machine learning ensembles 222a-n to provide results, recognize patterns, determine rules, or the like for use by the website adaptation module 206. While the machine learning module 204, in the depicted embodiment, includes multiple machine learning ensembles 222a-n, in other embodiments, the machine learning module 204 may include one or more single learned functions not organized into a machine learning ensemble 222; a single machine learning ensemble 222; tens, hundreds, or thousands of machine learning ensembles 222; or the like.

By generating a large number of learned functions, without regard to the effectiveness of the generated learned functions, without prior knowledge of the generated learned functions suitability, or the like, and evaluating the generated learned functions, in certain embodiments, the machine learning module 204 may provide machine learning ensembles 222a-n that are customized and finely tuned for particular website adaptations, without excessive intervention or fine-tuning. The machine learning module 204, in a further embodiment, may generate and evaluate a large number of learned functions using parallel computing on multiple processors, such as a massively parallel processing (MPP) system or the like. Machine learning ensembles 222 are described in greater detail below with regard to FIG. 3, FIG. 4, and FIG. 5.

In one embodiment, the website adaptation module 206 may adapt the website for the user in real time by using the offer module 232. In the depicted embodiment, the offer module 232 may configure the presentation of one or more marketing offers for the user based on the machine learning result from the machine learning module 204. In various embodiments, a marketing offer may include any discount or offer that may make a purchase more favorable for the user than it would be without the offer, whether the offer is specifically selected by the user or automatically applied. For example, in one embodiment, a marketing offer may notify the user that free shipping will be automatically applied when they purchase an item. In another embodiment, the user may select a marketing offer by clicking on an online coupon, entering a promotional code during checkout, or the like. In various embodiments, marketing offers may include various types of discounts, deals, or offers, such as free shipping discounts, percentage discounts, fixed dollar amount discounts, buy one get one free deals, discounts for aggregate purchases above a certain amount, or the like. Many useful types of marketing offers are clear in light of this disclosure.

In general, configuring the presentation of an element of a website, such as a marketing offer, may include determining the element's existence, substance, and/or presentational aspects. For example, in one embodiment, the offer module 232 may configure the presentation of one or more marketing offers by determining which offers, if any, to display. In another embodiment, the offer module 232 may configure the presentation of one or more marketing offers by determining the type or quantity of an offered discount. In a further embodiment, the offer module 232 may configure the presentation of one or more marketing offers by determining presentational aspects of an offer such as its size, color, position on a web page, timing, or the like. Many further ways of configuring the presentation of a marketing offer are clear in light of this disclosure.

In certain embodiments, configuring the presentation of a marketing offer based on a machine learning result from the machine learning module 204 may allow the website adaptation module 206 to present marketing offers efficiently. For example, in one embodiment, the machine learning result may predict a sufficient discount likely to induce the user to make a purchase. Higher discounts may also induce a purchase, but at the expense of profitability; lower discounts may not be sufficient to induce a purchase. In another embodiment, the machine learning result may predict a placement that makes a marketing offer more effective. Thus, by using machine learning results to configure the presentation of marketing offers, the offer module 232 may, in some embodiments, allow the website adaptation module 206 to adapt the website in ways that make it more profitable than otherwise for the website owner.

In one embodiment, the website adaptation module 206 may adapt the website for the user in real time by using the navigation module 234. In the depicted embodiment, the navigation module 234 may configure the presentation of one or more navigation links for the user based on the machine learning result from the machine learning module 204. In various embodiments, a navigation link allows the user to navigate to a different page or portion of the website, or to a different website. For example, in one embodiment, a user may click, select, or otherwise follow a navigation link to open a particular web page on the website. In another embodiment, a user may follow a navigation link to navigate to a particular portion of a web page. In some embodiments, a user may select a navigation link to display additional inline content without leaving the currently-displayed web page. In further embodiments, a navigation link may lead to a different website. For example, in one embodiment, a navigation link on one website for product reviews may lead to an affiliated website for product purchases. Many types of navigation link are clear in light of this disclosure.

In various embodiments, the navigation module 234 may configure the presentation of one or more navigation links in various ways. For example, in one embodiment, the navigation module 234 may configure the presentation of one or more navigation links by determining whether a navigation link should be presented. In another embodiment, the navigation module 234 may configure the presentation of one or more navigation links by determining what page or site to link to. In a further embodiment, the navigation module 234 may configure the presentation of one or more navigation links by determining presentational aspects of a link such as the link text, an image for the link, the size of the link, its position on a web page, or the like. Many further ways of configuring navigation links are clear in light of this disclosure.

In certain embodiments, using the navigation module 234 to configure the presentation of one or more navigation links based on a machine learning result from the machine learning module 204 may allow each user to navigate the website efficiently. For example, in one embodiment, the machine learning result may predict which web pages the user may want to visit or revisit, such as recently visited pages, related pages, pages for items frequently bought together, or the like.

In one embodiment, the website adaptation module 206 may adapt the website for the user in real time by using the search module 236. In the depicted embodiment, the search module 236 may configure the presentation of suggested search terms and/or search results for the user based on the machine learning result from the machine learning module 204. In certain embodiments, a query to an interface for searching the website may include one or more search terms, and the website may provide search results in response to the query. For example, in one embodiment, a user may type a search term into a text box interface for searching the website, and the website may provide search results including a list of web pages that are relevant to the search term. In another embodiment, the website may present one or more suggested search terms which the user may select to initiate a search, instead of manually entering search terms.

In various embodiments, the search module 236 may configure the presentation of suggested search terms and/or search results in various ways. For example, in one embodiment, the search module 236 may configure the presentation of suggested search terms by determining what search terms, if any, to present. In another embodiment, the search module 236 may configure the presentation of search terms by determining where and when to present suggested search terms: as options that drop down when a user is manually entering search terms, as suggestions presented with search results for modifying a search, as suggestions for searching for web pages related to a page the user is viewing, or the like. Similarly, in one embodiment, the search module 236 may configure the presentation of search results by determining what results to present. In another embodiment, the search module 236 may configure the presentation of search results by determining presentational aspects of the search results, such as the order of search results, what snippets of text or image thumbnails to include with the search results, how many results to display, or the like.

In certain embodiments, presenting suggested search terms and/or search results based on a machine learning result may allow the website adaptation module 206 to make relevant web pages for each user easier to find. For example, the machine learning result may predict which web pages a user is most likely to be interested in, and the search module 236 may configure the presentation of search results to display those web pages first. Similarly, the machine learning result may predict that are relevant to a user's interests, which the search module 236 may present as suggested search terms.

In one embodiment, the website adaptation module 206 may adapt the website for the user in real time by using the test module 238. In the depicted embodiment, the website adaptation module 206 uses the test module 238 to perform a test of the machine learning result from the machine learning module 204, by adapting the website in a way that fails to follow the machine learning result. The test module 238 may adapt the website in random or diverse ways, in various embodiments, to produce data that the machine learning module 204 may use to configure or reconfigure machine learning ensembles 222. Failing to follow the machine learning result may, in some embodiments, allow the test module 238 to determine an accuracy for the machine learning. The test module 238 may determine the accuracy of the machine learning result by comparing users' responses to the website when the machine learning result is followed to users' responses to the website when the machine learning result is not followed.

For example, in one embodiment, the machine learning result may indicate that a particular marketing offer will likely be sufficient to induce a user to purchase an item, but the test module 238 may select a different marketing offer to present to the user, or no marketing offer at all. In a further embodiment, the test module 238 may compare the purchasing behavior of users who receive the suggested marketing offer to the purchasing behavior of users who receive another marking offer, or no marketing offer, to determine the accuracy of the machine learning. Similarly, in another embodiment, the machine learning result may suggest putting navigation links in a particular location on a web page, but the test module 238 may present the navigation links in another location. In a further embodiment, the test module 238 may compare user responses to determine the location where users are more likely to use the navigation links, thus determining the accuracy of the machine learning.

In one embodiment, the machine learning module 204 may reconfigure the machine learning based on the determined accuracy of the machine learning from the test module 238. In a further embodiment, data from the test module 238, including the determined accuracy, may be added to the initialization data for the machine learning module 204, as training data and/or test data, which the machine learning module 204 may use to reconfigure the machine learning by creating new or updated machine learning ensembles 222. Configuring and evaluating machine learning based on initialization data that includes training data and test data is described further below with regard to FIGS. 3 and 4.

In one embodiment, the test module 238 is activated so that the website adaptation module 206 fails to follow the machine learning result in response to a test condition being satisfied. In various embodiments, the test condition may include any condition that, when satisfied, indicates that the test module 238 should fail to follow the machine learning result. In certain embodiments, the test module 238 may define the test condition based on a configuration setting from a website administrator for testing the machine learning. For example, in one embodiment, a website administrator may set or change a configuration setting so that the test module 238 performs a test with no marketing offer for ten percent of users who otherwise would have received a marketing offer based on a machine learning result. In a further embodiment, a test condition based on that configuration setting may be satisfied for every tenth user, or may be satisfied by randomly selecting ten percent of users. In view of this disclosure many ways of basing a test condition on a configuration setting are clear.

In certain embodiments, the test module 238 may refer to configuration settings from a website administrator, or to default configuration settings, as a basis for the test condition and also to determine additional aspects of a test. For example, in certain embodiments, the test module 238 may be configurable to perform blind or annotated tests. In one embodiment, in a blind test, the test module 238 does not indicate to the website administrator whether the website adaptation module 206 is following or failing to follow the machine learning result for each user. In another embodiment, in an annotated test, the test module 238 indicates to the website administrator (e.g., by recording a log) which users see a website adaptation based on the machine learning result, and which users see the test. In some embodiments, a configuration setting may determine whether the test module 238 performs a blind test or an annotated test. In another embodiment, a configuration setting may indicate what to do when the website adaptation module 206 fails to follow the machine learning result. For example, a configuration setting may indicate false machine learning results to use instead, or may indicate a range of options that the test module 238 may randomly select results from. Many other possible configuration settings for the test module 238 are clear in light of this disclosure.

FIG. 3 depicts one embodiment of a machine learning module 204. The machine learning module 204 of FIG. 3, in certain embodiments, may be substantially similar to the machine learning module 204 described above with regard to FIG. 2A and FIG. 2B. In the depicted embodiment, the machine learning module 204 includes a data receiver module 300, a function generator module 301, a machine learning compiler module 302, a feature selector module 304 a predictive correlation module 318, and a machine learning ensemble 222. The machine learning compiler module 302, in the depicted embodiment, includes a combiner module 306, an extender module 308, a synthesizer module 310, a function evaluator module 312, a metadata library 314, and a function selector module 316. The machine learning ensemble 222, in the depicted embodiment, includes an orchestration module 320, a synthesized metadata rule set 322, and synthesized learned functions 324.

The data receiver module 300, in certain embodiments, is configured to receive client data, such as training data, test data, workload data, or the like, from a web server 108, from the input module 202, or the like, either directly or indirectly. The data receiver module 300, in various embodiments, may receive data over a local channel such as an API, a shared library, a hardware command interface, or the like; over a data network 106 such as wired or wireless LAN, WAN, the Internet, a serial connection, a parallel connection, or the like. In certain embodiments, the data receiver module 300 may receive data indirectly from a client 104, from a web server 108, from the input module 202, or the like, through an intermediate module that may pre-process, reformat, or otherwise prepare the data for the machine learning module 204. The data receiver module 300 may support structured data, unstructured data, semi-structured data, or the like.

One type of data that the data receiver module 300 may receive, as part of a new ensemble request or the like, is initialization data. The machine learning module 204, in certain embodiments, may use initialization data to train and test learned functions from which the machine learning module 204 may build a machine learning ensemble 222. Initialization data may comprise historical data, statistics, Big Data, customer data, marketing data, computer system logs, computer application logs, data networking logs, or other data that a web server 108 provides to the data receiver module 300 with which to build, initialize, train, and/or test a machine learning ensemble 222. In one embodiment, initialization data, including training data and/or test data, may include historical information associated with the users of the website. For example, in a further embodiment, the historical information module 214 may receive historical information associated with multiple users, which the data receiver module 300 may use as initialization data.

Another type of data that the data receiver module 300 may receive, as part of an analysis request or the like, is workload data. The machine learning module 204, in certain embodiments, may process workload data using a machine learning ensemble 222 to obtain a result, such as a classification, a confidence metric, an inferred function, a regression function, an answer, a prediction, a recognized pattern, a rule, a recommendation, an evaluation, a marketing offer, a navigation link, a suggested search term, a search result, or the like. Workload data for a specific machine learning ensemble 222, in one embodiment, has substantially the same format as the initialization data used to train and/or evaluate the machine learning ensemble 222. For example, initialization data and/or workload data may include one or more features. As used herein, a feature may comprise a column, category, data type, attribute, characteristic, label, or other grouping of data. For example, in embodiments where initialization data and/or workload data that is organized in a table format, a column of data may be a feature. Initialization data and/or workload data may include one or more instances of the associated features. In a table format, where columns of data are associated with features, a row of data is an instance.

As described below with regard to FIG. 4, in one embodiment, the data receiver module 300 may maintain client data, such as initialization data and/or workload data, in a data repository 406, where the function generator module 301, the machine learning compiler module 302, or the like may access the data. In certain embodiments, as described below, the function generator module 301 and/or the machine learning compiler module 302 may divide initialization data into subsets, using certain subsets of data as training data for generating and training learned functions and using certain subsets of data as test data for evaluating generated learned functions.

The function generator module 301, in certain embodiments, is configured to generate a plurality of learned functions based on training data from the data receiver module 300. A learned function, as used herein, comprises a computer readable code that accepts an input and provides a result. A learned function may comprise a compiled code, a script, text, a data structure, a file, a function, or the like. In certain embodiments, a learned function may accept instances of one or more features as input, and provide a result, such as a classification, a confidence metric, an inferred function, a regression function, an answer, a prediction, a recognized pattern, a rule, a recommendation, an evaluation, a marketing offer, a navigation link, a suggested search term, a search result, or the like. In another embodiment, certain learned functions may accept instances of one or more features as input, and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 301 may generate learned functions from multiple different machine learning classes, models, or algorithms. For example, the function generator module 301 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Naïve Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 301 generates learned functions pseudo-randomly, without regard to the effectiveness of the generated learned functions, without prior knowledge regarding the suitability of the generated learned functions for the associated training data, or the like. For example, the function generator module 301 may generate a total number of learned functions that is large enough that at least a subset of the generated learned functions are statistically likely to be effective. As used herein, pseudo-randomly indicates that the function generator module 301 is configured to generate learned functions in an automated manner, without input or selection of learned functions, machine learning classes or models for the learned functions, or the like by a Data Scientist, expert, or other user.

The function generator module 301, in certain embodiments, generates as many learned functions as possible for a requested machine learning ensemble 222, given one or more parameters or limitations. A web server 108 may provide a parameter or limitation for learned function generation as part of a new ensemble request or the like to an interface module 402 as described below with regard to FIG. 4, such as an amount of time; an allocation of system resources such as a number of processor nodes or cores, or an amount of volatile memory; a number of learned functions; runtime constraints on the requested ensemble 222 such as an indicator of whether or not the requested ensemble 222 should provide results in real-time; and/or another parameter or limitation from a web server 108.

The number of learned functions that the function generator module 301 may generate for building a machine learning ensemble 222 may also be limited by capabilities of the system 100, such as a number of available processors or processor cores, a current load on the system 100, a price of remote processing resources over the data network 106; or other hardware capabilities of the system 100 available to the function generator module 301. The function generator module 301 may balance the hardware capabilities of the system 100 with an amount of time available for generating learned functions and building a machine learning ensemble 222 to determine how many learned functions to generate for the machine learning ensemble 222.

In one embodiment, the function generator module 301 may generate at least 50 learned functions for a machine learning ensemble 222. In a further embodiment, the function generator module 301 may generate hundreds, thousands, or millions of learned functions, or more, for a machine learning ensemble 222. By generating an unusually large number of learned functions from different classes without regard to the suitability or effectiveness of the generated learned functions for training data, in certain embodiments, the function generator module 301 ensures that at least a subset of the generated learned functions, either individually or in combination, are useful, suitable, and/or effective for the training data without careful curation and fine tuning by a Data Scientist or other expert.

Similarly, by generating learned functions from different machine learning classes without regard to the effectiveness or the suitability of the different machine learning classes for training data, the function generator module 301, in certain embodiments, may generate learned functions that are useful, suitable, and/or effective for the training data due to the sheer amount of learned functions generated from the different machine learning classes. This brute force, trial-and-error approach to generating learned functions, in certain embodiments, eliminates or minimizes the role of a Data Scientist or other expert in generation of a machine learning ensemble 222.

The function generator module 301, in certain embodiments, divides initialization data from the data receiver module 300 into various subsets of training data, and may use different training data subsets, different combinations of multiple training data subsets, or the like to generate different learned functions. The function generator module 301 may divide the initialization data into training data subsets by feature, by instance, or both. For example, a training data subset may comprise a subset of features of initialization data, a subset of features of initialization data, a subset of both features and instances of initialization data, or the like. Varying the features and/or instances used to train different learned functions, in certain embodiments, may further increase the likelihood that at least a subset of the generated learned functions are useful, suitable, and/or effective. In a further embodiment, the function generator module 301 ensures that the available initialization data is not used in its entirety as training data for any one learned function, so that at least a portion of the initialization data is available for each learned function as test data, which is described in greater detail below with regard to the function evaluator module 312 of FIG. 3.

In one embodiment, the function generator module 301 may also generate additional learned functions in cooperation with the machine learning compiler module 302. The function generator module 301 may provide a learned function request interface, allowing the machine learning compiler module 302 or another module, a web server 108, or the like to send a learned function request to the function generator module 301 requesting that the function generator module 301 generate one or more additional learned functions. In one embodiment, a learned function request may include one or more attributes for the requested one or more learned functions. For example, a learned function request, in various embodiments, may include a machine learning class for a requested learned function, one or more features for a requested learned function, instances from initialization data to use as training data for a requested learned function, runtime constraints on a requested learned function, or the like. In another embodiment, a learned function request may identify initialization data, training data, or the like for one or more requested learned functions and the function generator module 301 may generate the one or more learned functions pseudo-randomly, as described above, based on the identified data.

The machine learning compiler module 302, in one embodiment, is configured to form a machine learning ensemble 222 using learned functions from the function generator module 301. As used herein, a machine learning ensemble 222 comprises an organized set of a plurality of learned functions. Providing a classification, a confidence metric, an inferred function, a regression function, an answer, a prediction, a recognized pattern, a rule, a recommendation, a marketing offer, a navigation link, a suggested search term, a search result, or another result using a machine learning ensemble 222, in certain embodiments, may be more accurate than using a single learned function.

The machine learning compiler module 302 is described in greater detail below with regard to FIG. 3. The machine learning compiler module 302, in certain embodiments, may combine and/or extend learned functions to form new learned functions, may request additional learned functions from the function generator module 301, or the like for inclusion in a machine learning ensemble 222. In one embodiment, the machine learning compiler module 302 evaluates learned functions from the function generator module 301 using test data to generate evaluation metadata. The machine learning compiler module 302, in a further embodiment, may evaluate combined learned functions, extended learned functions, combined-extended learned functions, additional learned functions, or the like using test data to generate evaluation metadata.

The machine learning compiler module 302, in certain embodiments, maintains evaluation metadata in a metadata library 314, as described below with regard to FIGS. 3 and 4. The machine learning compiler module 302 may select learned functions (e.g. learned functions from the function generator module 301, combined learned functions, extended learned functions, learned functions from different machine learning classes, and/or combined-extended learned functions) for inclusion in a machine learning ensemble 222 based on the evaluation metadata. In a further embodiment, the machine learning compiler module 302 may synthesize the selected learned functions into a final, synthesized function or function set for a machine learning ensemble 222 based on evaluation metadata. The machine learning compiler module 302, in another embodiment, may include synthesized evaluation metadata in a machine learning ensemble 222 for directing data through the machine learning ensemble 222 or the like.

In one embodiment, the feature selector module 304 determines which features of initialization data to use in the machine learning ensemble 222, and in the associated learned functions, and/or which features of the initialization data to exclude from the machine learning ensemble 222, and from the associated learned functions. As described above, initialization data, and the training data and test data derived from the initialization data, may include one or more features. Learned functions and the machine learning ensembles 222 that they form are configured to receive and process instances of one or more features. Certain features may be more predictive than others, and the more features that the machine learning compiler module 302 processes and includes in the generated machine learning ensemble 222, the more processing overhead used by the machine learning compiler module 302, and the more complex the generated machine learning ensemble 222 becomes. Additionally, certain features may not contribute to the effectiveness or accuracy of the results from a machine learning ensemble 222, but may simply add noise to the results.

The feature selector module 304, in one embodiment, cooperates with the function generator module 301 and the machine learning compiler module 302 to evaluate the effectiveness of various features, based on evaluation metadata from the metadata library 314 described below. For example, the function generator module 301 may generate a plurality of learned functions for various combinations of features, and the machine learning compiler module 302 may evaluate the learned functions and generate evaluation metadata. Based on the evaluation metadata, the feature selector module 304 may select a subset of features that are most accurate or effective, and the machine learning compiler module 302 may use learned functions that utilize the selected features to build the machine learning ensemble 222. The feature selector module 304 may select features for use in the machine learning ensemble 222 based on evaluation metadata for learned functions from the function generator module 301, combined learned functions from the combiner module 306, extended learned functions from the extender module 308, combined extended functions, synthesized learned functions from the synthesizer module 310, or the like.

In a further embodiment, the feature selector module 304 may cooperate with the machine learning compiler module 302 to build a plurality of different machine learning ensembles 222 for the same initialization data or training data, each different machine learning ensemble 222 utilizing different features of the initialization data or training data. The machine learning compiler module 302 may evaluate each different machine learning ensemble 222, using the function evaluator module 312 described below, and the feature selector module 304 may select the machine learning ensemble 222 and the associated features which are most accurate or effective based on the evaluation metadata for the different machine learning ensembles 222. In certain embodiments, the machine learning compiler module 302 may generate tens, hundreds, thousands, millions, or more different machine learning ensembles 222 so that the feature selector module 304 may select an optimal set of features (e.g. the most accurate, most effective, or the like) with little or no input from a Data Scientist, expert, or other user in the selection process.

In one embodiment, the machine learning compiler module 302 may generate a machine learning ensemble 222 for each possible combination of features from which the feature selector module 304 may select. In a further embodiment, the machine learning compiler module 302 may begin generating machine learning ensembles 222 with a minimal number of features, and may iteratively increase the number of features used to generate machine learning ensembles 222 until an increase in effectiveness or usefulness of the results of the generated machine learning ensembles 222 fails to satisfy a feature effectiveness threshold. By increasing the number of features until the increases stop being effective, in certain embodiments, the machine learning compiler module 302 may determine a minimum effective set of features for use in a machine learning ensemble 222, so that generation and use of the machine learning ensemble 222 is both effective and efficient. The feature effectiveness threshold may be predetermined or hard coded, may be selected by a web server 108 as part of a new ensemble request or the like, may be based on one or more parameters or limitations, or the like.

During the iterative process, in certain embodiments, once the feature selector module 304 determines that a feature is merely introducing noise, the machine learning compiler module 302 excludes the feature from future iterations, and from the machine learning ensemble 222. In one embodiment, a web server 108 may identify one or more features as required for the machine learning ensemble 222, in a new ensemble request or the like. The feature selector module 304 may include the required features in the machine learning ensemble 222, and select one or more of the remaining optional features for inclusion in the machine learning ensemble 222 with the required features.

In a further embodiment, based on evaluation metadata from the metadata library 314, the feature selector module 304 determines which features from initialization data and/or training data are adding noise, are not predictive, are the least effective, or the like, and excludes the features from the machine learning ensemble 222. In other embodiments, the feature selector module 304 may determine which features enhance the quality of results, increase effectiveness, or the like, and selects the features for the machine learning ensemble 222.

In one embodiment, the feature selector module 304 causes the machine learning compiler module 302 to repeat generating, combining, extending, and/or evaluating learned functions while iterating through permutations of feature sets. At each iteration, the function evaluator module 312 may determine an overall effectiveness of the learned functions in aggregate for the current iteration's selected combination of features. Once the feature selector module 304 identifies a feature as noise introducing, the feature selector module may exclude the noisy feature and the machine learning compiler module 302 may generate a machine learning ensemble 222 without the excluded feature. In one embodiment, the predictive correlation module 318 determines one or more features, instances of features, or the like that correlate with higher confidence metrics (e.g. that are most effective in predicting results with high confidence). The predictive correlation module 318 may cooperate with, be integrated with, or otherwise work in concert with the feature selector module 304 to determine one or more features, instances of features, or the like that correlate with higher confidence metrics. For example, as the feature selector module 304 causes the machine learning compiler module 302 to generate and evaluate learned functions with different sets of features, the predictive correlation module 318 may determine which features and/or instances of features correlate with higher confidence metrics, are most effective, or the like based on metadata from the metadata library 314.

The predictive correlation module 318, in certain embodiments, is configured to harvest metadata regarding which features correlate to higher confidence metrics, to determine which feature was predictive of which outcome or result, or the like. In one embodiment, the predictive correlation module 318 determines the relationship of a feature's predictive qualities for a specific outcome or result based on each instance of a particular feature. In other embodiments, the predictive correlation module 318 may determine the relationship of a feature's predictive qualities based on a subset of instances of a particular feature. For example, the predictive correlation module 318 may discover a correlation between one or more features and the confidence metric of a predicted result by attempting different combinations of features and subsets of instances within an individual feature's dataset, and measuring an overall impact on predictive quality, accuracy, confidence, or the like. The predictive correlation module 318 may determine predictive features at various granularities, such as per feature, per subset of features, per instance, or the like.

In one embodiment, the predictive correlation module 318 determines one or more features with a greatest contribution to a predicted result or confidence metric as the machine learning compiler module 302 forms the machine learning ensemble 222, based on evaluation metadata from the metadata library 314, or the like. For example, the machine learning compiler module 302 may build one or more synthesized learned functions 324 that are configured to provide one or more features with a greatest contribution as part of a result. In another embodiment, the predictive correlation module 318 may determine one or more features with a greatest contribution to a predicted result or confidence metric dynamically at runtime as the machine learning ensemble 222 determines the predicted result or confidence metric. In such embodiments, the predictive correlation module 318 may be part of, integrated with, or in communication with the machine learning ensemble 222. The predictive correlation module 318 may cooperate with the machine learning ensemble 222, such that the machine learning ensemble 222 provides a listing of one or more features that provided a greatest contribution to a predicted result or confidence metric as part of a response to an analysis request.

In determining features that are predictive, or that have a greatest contribution to a predicted result or confidence metric, the predictive correlation module 318 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently, but has a very high impact on the predicted result or confidence metric (e.g. provides at or near 100% confidence or the like). While the predictive correlation module 318 is described herein as determining features that are predictive or that have a greatest contribution, in other embodiments, the predictive correlation module 318 may determine one or more specific instances of a feature that are predictive, have a greatest contribution to a predicted result or confidence metric, or the like.

In the depicted embodiment, the machine learning compiler module 302 includes a combiner module 306. The combiner module 306 combines learned functions, forming sets, strings, groups, trees, or clusters of combined learned functions. In certain embodiments, the combiner module 306 combines learned functions into a prescribed order, and different orders of learned functions may have different inputs, produce different results, or the like. The combiner module 306 may combine learned functions in different combinations. For example, the combiner module 306 may combine certain learned functions horizontally or in parallel, joined at the inputs and at the outputs or the like, and may combine certain learned functions vertically or in series, feeding the output of one learned function into the input of another learned function.

The combiner module 306 may determine which learned functions to combine, how to combine learned functions, or the like based on evaluation metadata for the learned functions from the metadata library 314, generated based on an evaluation of the learned functions using test data, as described below with regard to the function evaluator module 312. The combiner module 306 may request additional learned functions from the function generator module 301, for combining with other learned functions. For example, the combiner module 306 may request a new learned function with a particular input and/or output to combine with an existing learned function, or the like.

While the combining of learned functions may be informed by evaluation metadata for the learned functions, in certain embodiments, the combiner module 306 combines a large number of learned functions pseudo-randomly, forming a large number of combined functions. For example, the combiner module 306, in one embodiment, may determine each possible combination of generated learned functions, as many combinations of generated learned functions as possible given one or more limitations or constraints, a selected subset of combinations of generated learned functions, or the like, for evaluation by the function evaluator module 312. In certain embodiments, by generating a large number of combined learned functions, the combiner module 306 is statistically likely to form one or more combined learned functions that are useful and/or effective for the training data.

In the depicted embodiment, the machine learning compiler module 302 includes an extender module 308. The extender module 308, in certain embodiments, is configured to add one or more layers to a learned function. For example, the extender module 308 may extend a learned function or combined learned function by adding a probabilistic model layer, such as a Bayesian belief network layer, a Bayes classifier layer, a Boltzmann layer, or the like.

Certain classes of learned functions, such as probabilistic models, may be configured to receive either instances of one or more features as input, or the output results of other learned functions, such as a classification and a confidence metric, an inferred function, a regression function, an answer, a prediction, a recognized pattern, a rule, a recommendation, an evaluation, or the like. The extender module 308 may use these types of learned functions to extend other learned functions. The extender module 308 may extend learned functions generated by the function generator module 301 directly, may extend combined learned functions from the combiner module 306, may extend other extended learned functions, may extend synthesized learned functions from the synthesizer module 310, or the like.

In one embodiment, the extender module 308 determines which learned functions to extend, how to extend learned functions, or the like based on evaluation metadata from the metadata library 314. The extender module 308, in certain embodiments, may request one or more additional learned functions from the function generator module 301 and/or one or more additional combined learned functions from the combiner module 306, for the extender module 308 to extend.

While the extending of learned functions may be informed by evaluation metadata for the learned functions, in certain embodiments, the extender module 308 generates a large number of extended learned functions pseudo-randomly. For example, the extender module 308, in one embodiment, may extend each possible learned function and/or combination of learned functions, may extend a selected subset of learned functions, may extend as many learned functions as possible given one or more limitations or constraints, or the like, for evaluation by the function evaluator module 312. In certain embodiments, by generating a large number of extended learned functions, the extender module 308 is statistically likely to form one or more extended learned functions and/or combined extended learned functions that are useful and/or effective for the training data.

In the depicted embodiment, the machine learning compiler module 302 includes a synthesizer module 310. The synthesizer module 310, in certain embodiments, is configured to organize a subset of learned functions into the machine learning ensemble 222, as synthesized learned functions 324. In a further embodiment, the synthesizer module 310 includes evaluation metadata from the metadata library 314 of the function evaluator module 312 in the machine learning ensemble 222 as a synthesized metadata rule set 322, so that the machine learning ensemble 222 includes synthesized learned functions 324 and evaluation metadata, the synthesized metadata rule set 322, for the synthesized learned functions 324.

The learned functions that the synthesizer module 310 synthesizes or organizes into the synthesized learned functions 324 of the machine learning ensemble 222, may include learned functions directly from the function generator module 301, combined learned functions from the combiner module 306, extended learned functions from the extender module 308, combined extended learned functions, or the like. As described below, in one embodiment, the function selector module 316 selects the learned functions for the synthesizer module 310 to include in the machine learning ensemble 222. In certain embodiments, the synthesizer module 310 organizes learned functions by preparing the learned functions and the associated evaluation metadata for processing workload data to reach a result. For example, as described below, the synthesizer module 310 may organize and/or synthesize the synthesized learned functions 324 and the synthesized metadata rule set 322 for the orchestration module 320 to use to direct workload data through the synthesized learned functions 324 to produce a result.

In one embodiment, the function evaluator module 312 evaluates the synthesized learned functions 324 that the synthesizer module 310 organizes, and the synthesizer module 310 synthesizes and/or organizes the synthesized metadata rule set 322 based on evaluation metadata that the function evaluation module 312 generates during the evaluation of the synthesized learned functions 324, from the metadata library 314 or the like.

In the depicted embodiment, the machine learning compiler module 302 includes a function evaluator module 312. The function evaluator module 312 is configured to evaluate learned functions using test data, or the like. The function evaluator module 312 may evaluate learned functions generated by the function generator module 301, learned functions combined by the combiner module 306 described above, learned functions extended by the extender module 308 described above, combined extended learned functions, synthesized learned functions 324 organized into the machine learning ensemble 222 by the synthesizer module 310 described above, or the like.

Test data for a learned function, in certain embodiments, comprises a different subset of the initialization data for the learned function than the function generator module 301 used as training data. The function evaluator module 312, in one embodiment, evaluates a learned function by inputting the test data into the learned function to produce a result, such as a classification, a confidence metric, an inferred function, a regression function, an answer, a prediction, a recognized pattern, a rule, a recommendation, an evaluation, a marketing offer, a navigation link, a suggested search term, a search result, or another result.

Test data, in certain embodiments, comprises a subset of initialization data, with a feature associated with the requested result removed, so that the function evaluator module 312 may compare the result from the learned function to the instances of the removed feature to determine the accuracy and/or effectiveness of the learned function for each test instance. For example, if a web server 108 has requested a machine learning ensemble 222 to predict whether a customer will be a repeat customer, and provided historical customer information as initialization data, the function evaluator module 312 may input a test data set comprising one or more features of the initialization data other than whether the customer was a repeat customer into the learned function, and compare the resulting predictions to the initialization data to determine the accuracy and/or effectiveness of the learned function.

The function evaluator module 312, in one embodiment, is configured to maintain evaluation metadata for an evaluated learned function in the metadata library 314. The evaluation metadata, in certain embodiments, comprises log data generated by the function generator module 301 while generating learned functions, the function evaluator module 312 while evaluating learned functions, or the like.

In one embodiment, the evaluation metadata includes indicators of one or more training data sets that the function generator module 301 used to generate a learned function. The evaluation metadata, in another embodiment, includes indicators of one or more test data sets that the function evaluator module 312 used to evaluate a learned function. In a further embodiment, the evaluation metadata includes indicators of one or more decisions made by and/or branches taken by a learned function during an evaluation by the function evaluator module 312. The evaluation metadata, in another embodiment, includes the results determined by a learned function during an evaluation by the function evaluator module 312. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data, and may be represented by a correctness indicator for each evaluated instance, a percentage, a ratio, or the like. Different classes of learned functions, in certain embodiments, may have different types of evaluation metadata.

The metadata library 314, in one embodiment, provides evaluation metadata for learned functions to the feature selector module 304, the predictive correlation module 318, the combiner module 306, the extender module 308, and/or the synthesizer module 310. The metadata library 314 may provide an API, a shared library, one or more function calls, or the like providing access to evaluation metadata. The metadata library 314, in various embodiments, may store or maintain evaluation metadata in a database format, as one or more flat files, as one or more lookup tables, as a sequential log or log file, or as one or more other data structures. In one embodiment, the metadata library 314 may index evaluation metadata by learned function, by feature, by instance, by training data, by test data, by effectiveness, and/or by another category or attribute and may provide query access to the indexed evaluation metadata. The function evaluator module 312 may update the metadata library 314 in response to each evaluation of a learned function, adding evaluation metadata to the metadata library 314 or the like.

The function selector module 316, in certain embodiments, may use evaluation metadata from the metadata library 314 to select learned functions for the combiner module 306 to combine, for the extender module 308 to extend, for the synthesizer module 310 to include in the machine learning ensemble 222, or the like. For example, in one embodiment, the function selector module 316 may select learned functions based on evaluation metrics, learning metrics, effectiveness metrics, convergence metrics, or the like. In another embodiment, the function selector module 316 may select learned functions for the combiner module 306 to combine and/or for the extender module 308 to extend based on features of training data used to generate the learned functions, or the like.

The machine learning ensemble 222, in certain embodiments, provides machine learning results for an analysis request by processing workload data of the analysis request using a plurality of learned functions (e.g., the synthesized learned functions 324). As described above, results from the machine learning ensemble 222, in various embodiments, may include a classification, a confidence metric, an inferred function, a regression function, an answer, a prediction, a recognized pattern, a rule, a recommendation, an evaluation, a marketing offer, a navigation link, a suggested search term, a search result, and/or another result. For example, in one embodiment, the machine learning ensemble 222 provides a classification and a confidence metric for each instance of workload data input into the machine learning ensemble 222, or the like. Workload data, in certain embodiments, may be substantially similar to test data, but the missing feature from the initialization data is not known, and is to be solved for by the machine learning ensemble 222. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes or no), a rating on a scale (e.g., 4 on a scale of 1 to 5), or another data type for a feature. A confidence metric, in certain embodiments, may comprise a percentage, a ratio, a rating on a scale, or another indicator of accuracy, effectiveness, and/or confidence.

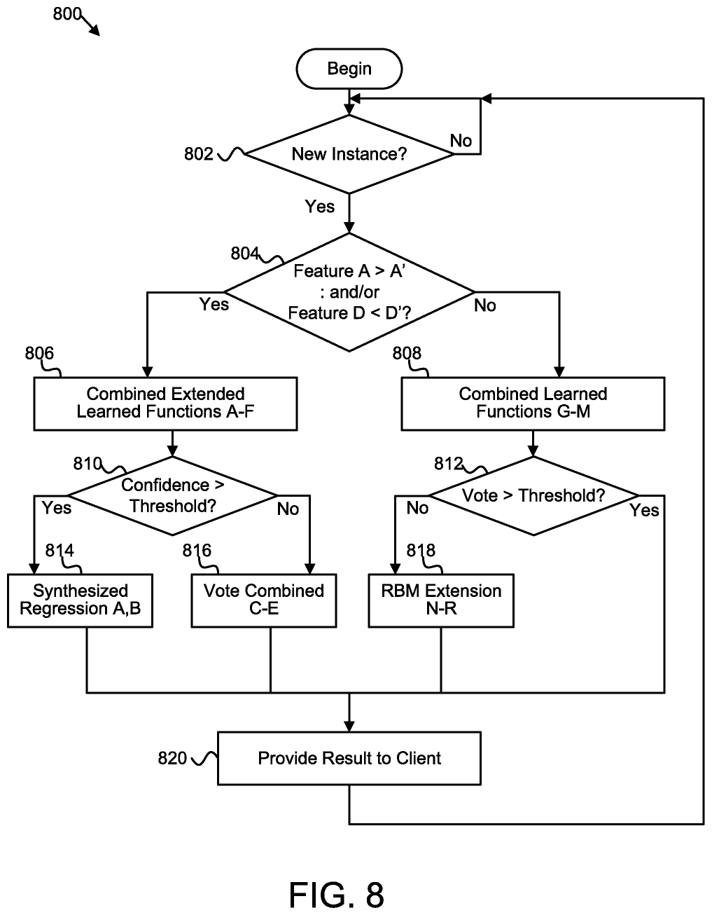

In the depicted embodiment, the machine learning ensemble 222 includes an orchestration module 320. The orchestration module 320, in certain embodiments, is configured to direct workload data through the machine learning ensemble 222 to produce a result, such as a classification, a confidence metric, an inferred function, a regression function, an answer, a prediction, a recognized pattern, a rule, a recommendation, an evaluation, a marketing offer, a navigation link, a suggested search term, a search result, and/or another result. In one embodiment, the orchestration module 320 uses evaluation metadata from the function evaluator module 312 and/or the metadata library 314, such as the synthesized metadata rule set 322, to determine how to direct workload data through the synthesized learned functions 324 of the machine learning ensemble 222. As described below with regard to FIG. 8, in certain embodiments, the synthesized metadata rule set 322 comprises a set of rules or conditions from the evaluation metadata of the metadata library 314 that indicate to the orchestration module 320 which features, instances, or the like should be directed to which synthesized learned function 324.

For example, the evaluation metadata from the metadata library 314 may indicate which learned functions were trained using which features and/or instances, how effective different learned functions were at making predictions based on different features and/or instances, or the like. The synthesizer module 310 may use that evaluation metadata to determine rules for the synthesized metadata rule set 322, indicating which features, which instances, or the like the orchestration module 320 the orchestration module 320 should direct through which learned functions, in which order, or the like. The synthesized metadata rule set 322, in one embodiment, may comprise a decision tree or other data structure comprising rules which the orchestration module 320 may follow to direct workload data through the synthesized learned functions 324 of the machine learning ensemble 222.

FIG. 4 depicts one embodiment of a system 400 for a machine learning factory. The system 400, in the depicted embodiment, includes several clients 404 in communication with an interface module 402 either locally or over a data network 106. The machine learning module 204 of FIG. 4 is substantially similar to the machine learning module 204 of FIG. 3, but further includes an interface module 402 and a data repository 406.

The interface module 402, in certain embodiments, is configured to receive requests from clients 404, to provide results to a client 404, or the like. The machine learning module 204, for example, may act as a client 404, requesting a machine learning ensemble 222 from the interface module 402 or the like. The interface module 402 may provide a machine learning interface to clients 404, such as an API, a shared library, a hardware command interface, or the like, over which clients 404 may make requests and receive results. The interface module 402 may support new ensemble requests from clients 404, allowing clients 404 to request generation of a new machine learning ensemble 222 from the machine learning module 204 or the like. As described above, a new ensemble request may include initialization data; one or more ensemble parameters; a feature, query, question or the like for which a client 404 would like a machine learning ensemble 222 to predict a result; or the like. The interface module 402 may support analysis requests for a result from a machine learning ensemble 222. As described above, an analysis request may include workload data; a feature, query, question or the like; a machine learning ensemble 222; or may include other analysis parameters.

In certain embodiments, the machine learning module 204 may maintain a library of generated machine learning ensembles 222, from which clients 404 may request results. In such embodiments, the interface module 402 may return a reference, pointer, or other identifier of the requested machine learning ensemble 222 to the requesting client 404, which the client 404 may use in analysis requests. In another embodiment, in response to the machine learning module 204 generating a machine learning ensemble 222 to satisfy a new ensemble request, the interface module 402 may return the actual machine learning ensemble 222 to the client 404, for the client 404 to manage, and the client 404 may include the machine learning ensemble 222 in each analysis request.

The interface module 402 may cooperate with the machine learning module 204 to service new ensemble requests, may cooperate with the machine learning ensemble 222 to provide a result to an analysis request, or the like. The machine learning module 204, in the depicted embodiment, includes the function generator module 301, the feature selector module 304, the predictive correlation module 318, and the machine learning compiler module 302, as described above. The machine learning module 204, in the depicted embodiment, also includes a data repository 406.

The data repository 406, in one embodiment, stores initialization data, so that the function generator module 301, the feature selector module 304, the predictive correlation module 318, and/or the machine learning compiler module 302 may access the initialization data to generate, combine, extend, evaluate, and/or synthesize learned functions and machine learning ensembles 222. The data repository 406 may provide initialization data indexed by feature, by instance, by training data subset, by test data subset, by new ensemble request, or the like. By maintaining initialization data in a data repository 406, in certain embodiments, the machine learning module 204 ensures that the initialization data is accessible throughout the machine learning ensemble 222 building process, for the function generator module 301 to generate learned functions, for the feature selector module 304 to determine which features should be used in the machine learning ensemble 222, for the predictive correlation module 318 to determine which features correlate with the highest confidence metrics, for the combiner module 306 to combine learned functions, for the extender module 308 to extend learned functions, for the function evaluator module 312 to evaluate learned functions, for the synthesizer module 310 to synthesize learned functions 324 and/or metadata rule sets 322, or the like.

In the depicted embodiment, the data receiver module 300 is integrated with the interface module 402, to receive initialization data, including training data and test data, from new ensemble requests. The data receiver module 300 stores initialization data in the data repository 406. The function generator module 301 is in communication with the data repository 406, in one embodiment, so that the function generator module 301 may generate learned functions based on training data sets from the data repository 406. The feature selector module 300 and/or the predictive correlation module 318, in certain embodiments, may cooperate with the function generator module 301 and/or the machine learning compiler module 302 to determine which features to use in the machine learning ensemble 222, which features are most predictive or correlate with the highest confidence metrics, or the like.

Within the machine learning compiler module 302, the combiner module 306, the extender module 308, and the synthesizer module 310 are each in communication with both the function generator module 301 and the function evaluator module 312. The function generator module 301, as described above, may generate an initial large amount of learned functions, from different classes or the like, which the function evaluator module 312 evaluates using test data sets from the data repository 406. The combiner module 306 may combine different learned functions from the function generator module 301 to form combined learned functions, which the function evaluator module 312 evaluates using test data from the data repository 406. The combiner module 306 may also request additional learned functions from the function generator module 301.

The extender module 308, in one embodiment, extends learned functions from the function generator module 301 and/or the combiner module 306. The extender module 308 may also request additional learned functions from the function generator module 301. The function evaluator module 312 evaluates the extended learned functions using test data sets from the data repository 406. The synthesizer module 310 organizes, combines, or otherwise synthesizes learned functions from the function generator module 301, the combiner module 306, and/or the extender module 308 into synthesized learned functions 324 for the machine learning ensemble 222. The function evaluator module 312 evaluates the synthesized learned functions 324, and the synthesizer module 310 organizes or synthesizes the evaluation metadata from the metadata library 314 into a synthesized metadata rule set 322 for the synthesized learned functions 324.

As described above, as the function evaluator module 312 evaluates learned functions from the function generator module 301, the combiner module 306, the extender module 308, and/or the synthesizer module 310, the function evaluator module 312 generates evaluation metadata for the learned functions and stores the evaluation metadata in the metadata library 314. In the depicted embodiment, in response to an evaluation by the function evaluator module 312, the function selector module 316 selects one or more learned functions based on evaluation metadata from the metadata library 314. For example, the function selector module 316 may select learned functions for the combiner module 306 to combine, for the extender module 308 to extend, for the synthesizer module 310 to synthesize, or the like.

FIG. 5 depicts one embodiment 500 of learned functions 502, 504, 506 for a machine learning ensemble 222. The learned functions 502, 504, 506 are presented by way of example, and in other embodiments, other types and combinations of learned functions may be used, as described above. Further, in other embodiments, the machine learning ensemble 222 may include an orchestration module 320, a synthesized metadata rule set 322, or the like. In one embodiment, the function generator module 301 generates the learned functions 502. The learned functions 502, in the depicted embodiment, include various collections of selected learned functions 502 from different classes including a collection of decision trees 502a, configured to receive or process a subset A-F of the feature set of the machine learning ensemble 222, a collection of support vector machines (“SVMs”) 502b with certain kernels and with an input space configured with particular subsets of the feature set G-L, and a selected group of regression models 502c, here depicted as a suite of single layer (“SL”) neural nets trained on certain feature sets K-N.

The example combined learned functions 504, combined by the combiner module 306 or the like, include various instances of forests of decision trees 504a configured to receive or process features N-S, a collection of combined trees with support vector machine decision nodes 504b with specific kernels, their parameters and the features used to define the input space of features T-U, as well as combined functions 504c in the form of trees with a regression decision at the root and linear, tree node decisions at the leaves, configured to receive or process features L-R.

Component class extended learned functions 506, extended by the extender module 308 or the like, include a set of extended functions such as a forest of trees 506a with tree decisions at the roots and various margin classifiers along the branches, which have been extended with a layer of Boltzmann type Bayesian probabilistic classifiers. Extended learned function 506b includes a tree with various regression decisions at the roots, a combination of standard tree 504b and regression decision tree 504c and the branches are extended by a Bayes classifier layer trained with a particular training set exclusive of those used to train the nodes.

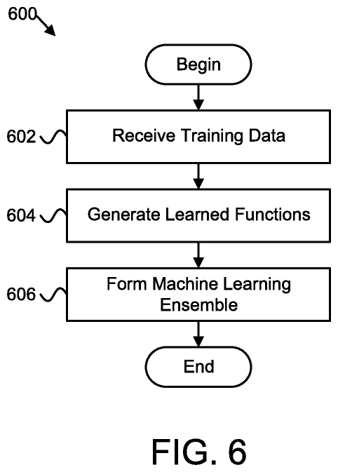

FIG. 6 depicts one embodiment of a method 600 for a machine learning factory. The method 600 begins, and the data receiver module 300 receives 602 training data. The function generator module 301 generates 604 a plurality of learned functions from multiple classes based on the received 602 training data. The machine learning compiler module 302 forms 606 a machine learning ensemble comprising a subset of learned functions from at least two classes, and the method 600 ends.

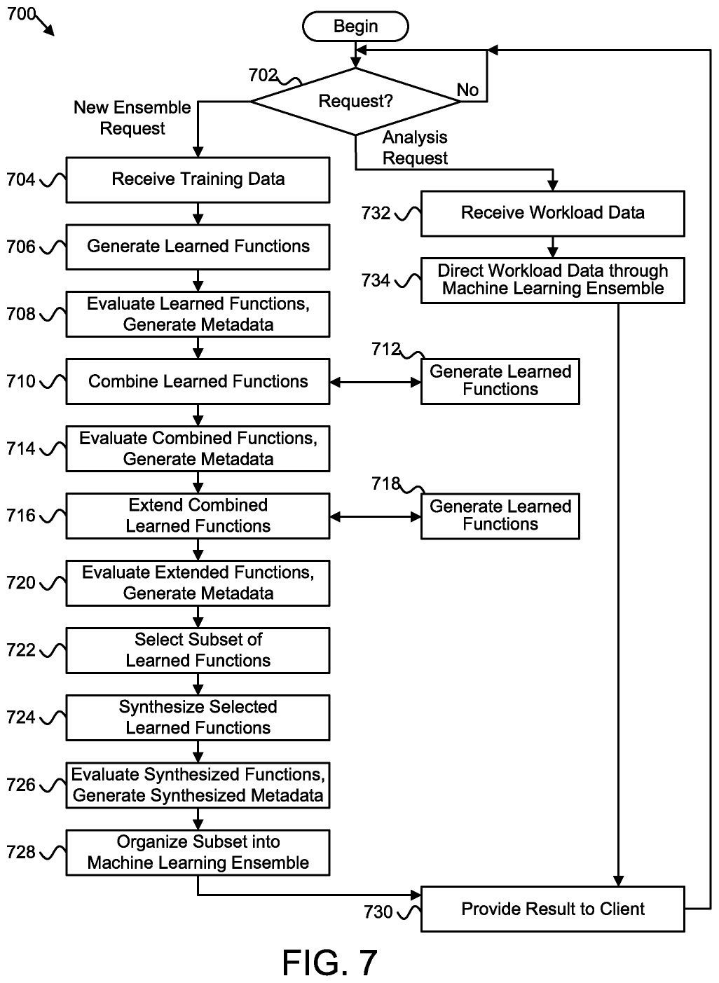

FIG. 7 depicts another embodiment of a method 700 for a machine learning factory. The method 700 begins, and the interface module 402 monitors 702 requests until the interface module 402 receives 702 an analytics request from a client 404 or the like.

If the interface module 402 receives 702 a new ensemble request, the data receiver module 300 receives 704 training data for the new ensemble, as initialization data or the like. The function generator module 301 generates 706 a plurality of learned functions based on the received 704 training data, from different machine learning classes. The function evaluator module 312 evaluates 708 the plurality of generated 706 learned functions to generate evaluation metadata. The combiner module 306 combines 710 learned functions based on the metadata from the evaluation 708. The combiner module 306 may request that the function generator module 301 generate 712 additional learned functions for the combiner module 306 to combine.

The function evaluator module 312 evaluates 714 the combined 710 learned functions and generates additional evaluation metadata. The extender module 308 extends 716 one or more learned functions by adding one or more layers to the one or more learned functions, such as a probabilistic model layer or the like. In certain embodiments, the extender module 308 extends 716 combined 710 learned functions based on the evaluation 712 of the combined learned functions. The extender module 308 may request that the function generator module 301 generate 718 additional learned functions for the extender module 308 to extend. The function evaluator module 312 evaluates 720 the extended 716 learned functions. The function selector module 316 selects 722 at least two learned functions, such as the generated 706 learned functions, the combined 710 learned functions, the extended 716 learned functions, or the like, based on evaluation metadata from one or more of the evaluations 708, 714, 720.

The synthesizer module 310 synthesizes 724 the selected 722 learned functions into synthesized learned functions 324. The function evaluator module 312 evaluates 726 the synthesized learned functions 324 to generate a synthesized metadata rule set 322. The synthesizer module 310 organizes 728 the synthesized 724 learned functions 324 and the synthesized metadata rule set 322 into a machine learning ensemble 222. The interface module 402 provides 730 a result to the requesting client 404, such as the machine learning ensemble 222, a reference to the machine learning ensemble 222, an acknowledgment, or the like, and the interface module 402 continues to monitor 702 requests.

If the interface module 402 receives 702 an analysis request, the data receiver module 300 receives 732 workload data associated with the analysis request. The orchestration module 320 directs 734 the workload data through a machine learning ensemble 222 associated with the received 702 analysis request to produce a result, such as a classification, a confidence metric, an inferred function, a regression function, an answer, a recognized pattern, a recommendation, an evaluation, a marketing offer, a navigation link, a suggested search term, a search result, and/or another result. The interface module 402 provides 730 the produced result to the requesting client 404, and the interface module 402 continues to monitor 702 requests.

FIG. 8 depicts one embodiment of a method 800 for directing data through a machine learning ensemble. The specific synthesized metadata rule set 322 of the depicted method 800 is presented by way of example only, and many other rules and rule sets may be used.

A new instance of workload data is presented 802 to the machine learning ensemble 222 through the interface module 402. The data is processed through the data receiver module 300 and configured for the particular analysis request as initiated by a client 404. In this embodiment the orchestration module 320 evaluates a certain set of features associates with the data instance against a set of thresholds contained within the synthesized metadata rule set 322.

A binary decision 804 passes the instance to, in one case, a certain combined and extended function 806 configured for features A-F or in the other case a different, parallel combined function 808 configured to predict against a feature set G-M. In the first case 806, if the output confidence passes 810 a certain threshold as given by the meta-data rule set the instance is passed to a synthesized, extended regression function 814 for final evaluation, else the instance is passed to a combined collection 816 whose output is a weighted voted based processing a certain set of features. In the second case 808 a different combined function 812 with a simple vote output results in the instance being evaluated by a set of base learned functions extended by a Boltzmann type extension 818 or, if a prescribed threshold is meet the output of the synthesized function is the simple vote. The interface module 402 provides 820 the result of the orchestration module directing workload data through the machine learning ensemble 222 to a requesting client 404 and the method 800 continues.

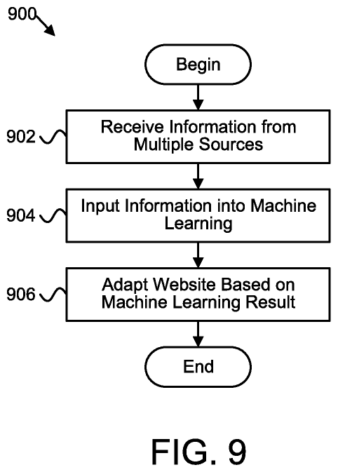

FIG. 9 depicts one embodiment of a method 900 for website interaction. The method 900 begins, and the input module 202 receives 902 information associated with a user of a website from multiple sources. The machine learning module 204 inputs 904 the information into machine learning to produce a machine learning result. The website adaptation module 206 adapts 906 the website for the user in real-time based on the machine learning result, and the method 900 ends.

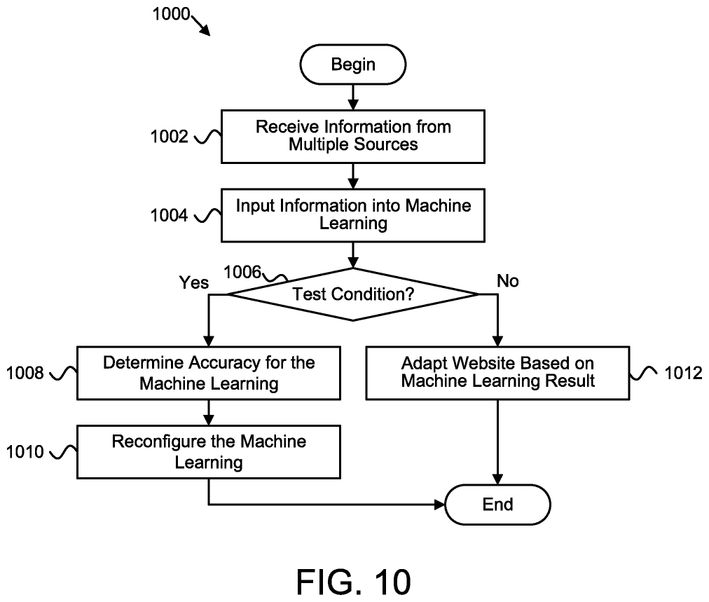

FIG. 10 depicts another embodiment of a method 1000 for website interaction. The method 1000 begins, and the input module 202 receives 1002 information associated with a user of a website from multiple sources. The machine learning module 204 inputs 1004 the information into machine learning to produce a machine learning result. The test module 238 determines 1006 whether a test condition is satisfied. If the test condition is not satisfied, the website adaptation module 206 adapts 1012 the website for the user in real-time based on the machine learning result, and the method 1000 ends. If the test condition is satisfied, the test module 238 determines 1008 an accuracy for the machine learning by failing to follow the machine learning result. The machine learning module 204 reconfigures 1010 the machine learning based on the determined accuracy for the machine learning from the test module 238, and the method 1000 ends.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus for a machine learning factory, the apparatus comprising:
a receiver module configured to receive electronically transmitted training data over a data network using a network interface, the training data for forming a machine learning ensemble customized for the training data;
a function generator module configured to pseudo-randomly generate executable program code for a plurality of learned functions from a plurality of different machine learning classes using parallel computing on multiple processors based on the training data, the different machine learning classes selected without regard to a suitability of the plurality of learned functions and of the different machine learning classes for the training data, a total number of the plurality of learned functions selected such that at least a subset of the plurality of learned functions are pseudo-randomly suitable for the training data;
a function evaluator module configured to perform a machine learning evaluation of the plurality of learned functions using test data and to maintain evaluation metadata for the plurality of learned functions in one or more non-transitory computer readable storage media, the evaluation metadata comprising one or more of an indicator of a training data set used to generate a learned function and an indicator of one or more decisions made by a learned function during the machine learning evaluation; and
a machine learning compiler module configured to compile the executable program code from a subset of multiple learned functions from the plurality of learned functions to form the machine learning ensemble, the machine learning ensemble comprising the subset of multiple learned functions selected and combined based on the evaluation metadata for the plurality of learned functions, and comprising a rule set synthesized from the evaluation metadata to direct data through the multiple learned functions such that executable program code from different learned functions of the machine learning ensemble processes different subsets of the data based on the evaluation metadata and such that executable program code from one or more of the multiple learned functions receives output from executable program code of at least one other learned function of the multiple learned functions as an input.

2. The apparatus of claim 1, further comprising a feature selector module configured to, in response to the function generator module generating the executable program code for the plurality of learned functions, determine a subset of features from the training data for use in the machine learning ensemble based on the evaluation metadata, the machine learning compiler module configured to form the machine learning ensemble using the selected subset of features.

3. The apparatus of claim 2, wherein the feature selector module is configured to iteratively increase a size of the subset of features until a subsequent increase in the size fails to satisfy a feature effectiveness threshold.

4. The apparatus of claim 2, wherein one or more of the features of the training data are selected by a user as required and the feature selector module is configured to select one or more optional features to include in the subset of features with the required one or more features.

5. The apparatus of claim 1, wherein the function evaluator module is configured to perform the machine learning evaluation of the plurality of learned functions using the test data by inputting the test data into the plurality of learned functions to output the one or more decisions.

6. The apparatus of claim 5, wherein the function evaluator module is configured to maintain the evaluation metadata for each evaluated learned function in a metadata library stored on the one or more non-transitory computer readable storage media, the machine learning compiler module configured to include the rule set in the machine learning ensemble, the rule set comprising at least a portion of the evaluation metadata.

7. The apparatus of claim 6, wherein the evaluation metadata further comprises one or more of the training data, classification metadata, convergence metrics, and efficacy metrics for the plurality of learned functions.

8. The apparatus of claim 1, wherein the machine learning compiler module is configured to combine learned functions from the plurality of learned functions to form combined learned functions, the machine learning ensemble comprising at least one combined learned function.

9. The apparatus of claim 8, wherein the function generator module is configured to determine one or more additional learned functions in response to a learned function request, the machine learning compiler module configured to request one or more additional learned functions from the function generator to combine with learned functions from the plurality of learned functions.

10. The apparatus of claim 1, wherein the machine learning compiler module is configured to add one or more layers to at least a portion of the plurality of learned functions to form one or more extended learned functions, at least one of the one or more layers comprising one or more of a Bayes classifier and a Boltzmann machine, the at least one other learned function comprising an extended learned function extended with the one or more of the multiple learned functions.

11. The apparatus of claim 1, wherein the machine learning compiler module is configured to form the machine learning ensemble by organizing the subset of learned functions into the machine learning ensemble, the machine learning ensemble comprising the subset of learned functions and the rule set synthesized from the evaluation metadata for the subset of learned functions.

12. The apparatus of claim 1, further comprising an orchestration module configured to direct workload data through the machine learning ensemble based on the evaluation metadata data to produce a classification for the workload data and a confidence metric for the classification, the evaluation metadata synthesized to form the rule set for the subset of learned functions.

13. The apparatus of claim 1, further comprising an interface module configured to receive an analytics request from a client and to provide an analytics result to the client, the analytics request comprising workload data with similar features to the training data, the analytics result produced by the machine learning ensemble.

14. An apparatus for a machine learning factory, the apparatus comprising:
means for generating executable program code for a plurality of learned functions from a plurality of different machine learning classes based on training data without regard to a suitability of the plurality of learned functions and of the different machine learning classes for the training data, the training data received for forming a machine learning ensemble customized for the training data;
means for evaluating the plurality of learned functions using test data to generate evaluation metadata stored in one or more non-transitory computer readable storage media, the evaluation metadata indicating an effectiveness of different learned functions at making predictions based on different subsets of the test data; and
means for compiling executable program code from a subset of multiple learned functions from the plurality of learned functions to form the machine learning ensemble, the machine learning ensemble comprising the subset of multiple learned functions selected and combined based on the evaluation metadata, and comprising a rule set synthesized from the evaluation metadata to direct different subsets of the workload data through executable program code from different learned functions of the multiple learned functions based on the evaluation metadata.

15. The apparatus of claim 14, further comprising means for synthesizing the evaluation metadata into a rule set for the subset of learned functions, wherein the means for compiling executable code to form the machine learning ensemble further comprises means for including the rule set in the machine learning ensemble.

16. The apparatus of claim 14, wherein the means for compiling executable program code forms the machine learning ensemble by one or more of:
combining learned functions from the plurality of learned functions to form a combined learned function; and
adding one or more layers to a learned function from the plurality of learned functions to form an extended learned function.

17. A computer program product comprising a non-transitory computer readable storage medium storing computer usable program code executable to perform operations for a machine learning factory, the operations comprising:
determining executable program code for a plurality of learned functions from a plurality of different machine learning classes using training data without regard to a suitability of the plurality of learned functions and of the different machine learning classes for the training data, the training data comprising a plurality of features, the training data received for forming a machine learning ensemble customized for the training data;
selecting a subset of the features of the training data based on evaluation metadata generated for the plurality of learned functions and stored in one or more non-transitory computer readable storage media, the evaluation metadata comprising an effectiveness metric for a learned function; and
compiling executable program code from a subset of multiple learned functions from the plurality of learned functions to form the machine learning ensemble, the machine learning ensemble comprising at least two learned functions from the plurality of learned functions, the at least two learned functions using the selected subset of features, the at least two learned functions selected and combined based on the evaluation metadata, the machine learning ensemble comprising a rule set synthesized from the evaluation metadata to direct data through executable program code from the at least two learned functions so that executable program code from different learned functions process different features of the selected subset of features.

18. The computer program product of claim 17, wherein the operations further comprise evaluating the plurality of learned functions using test data to generate the evaluation metadata.

19. The computer program product of claim 18, wherein evaluating the plurality of learned functions comprises generating a machine learning ensemble for each possible combination of features of the training data and evaluating each generated machine learning ensemble using the test data.

20. The computer program product of claim 17, wherein the operations further comprise iteratively increasing a size of the subset of features until a subsequent increase in the size fails to satisfy a feature effectiveness threshold.

21. The computer program product of claim 17, wherein the operations further comprise identifying one or more of the plurality of features as noisy and excluding the noisy features from the selected subset of features.

22. The computer program product of claim 17, wherein one or more of the features of the training data are selected by a user as required for inclusion in the subset of features.

23. A machine learning ensemble comprising:
executable program code for multiple learned functions synthesized from executable program code for a larger plurality of learned functions from a plurality of different machine learning classes, the multiple learned functions selected and combined based on evaluation metadata for an evaluation of the larger plurality of learned functions, wherein the larger plurality of learned functions are generated based on training data without regard to a suitability of the larger plurality of learned functions and of the different machine learning classes for the training data;
a metadata rule set synthesized from the evaluation metadata for the plurality of learned functions for directing data through executable program code of different learned functions of the multiple learned functions to produce a result; and
an orchestration module configured to direct the data through the executable program code of the different learned functions of the multiple learned functions based on the synthesized metadata rule set to produce the result.

24. The machine learning ensemble of claim 23, further comprising a predictive correlation module configured to correlate one or more features of the multiple learned functions with a confidence metric associated with the result.

25. The machine learning ensemble of claim 24, wherein the predictive correlation module is configured to provide a listing of the one or more features correlated with the result to a client.
